(19) United States
(12) Patent Application Publication
(10) Pub. No.: US 2024/0281996 A1
(43) Pub. Date: Aug. 22, 2024

(54) SYSTEMS AND METHODS FOR MOTION BLUR COMPENSATION FOR FEATURE TRACKING

(71) Applicant: QUALCOMM Incorporated, San Diego, CA (US)

(72) Inventors: Srujan Babu NANDIPATI, Bangalore (IN); Chiranjib CHOUDHURI, Bangalore (IN); Pushkar GORUR SHESHAGIRI, Bengaluru (IN); Vinod Kumar SAINI, Bengaluru (IN); Ajit Deepak GUPTE, Bangalore (IN)

(21) Appl. No.: 18/110,803

(22) Filed: Feb. 16, 2023

(51) Int. Cl. G06T 7/73; G06T 7/246; H04N 23/68

(52) U.S. Cl. CPC G06T 7/73; G06T 7/246; H04N 23/6812; G06T 2207/10028; G06T 2207/30244; H04N 23/682

(57) ABSTRACT

Imaging systems and techniques are described. A system receives an image of an environment captured using an image sensor according to an image capture setting, and receives motion data captured using a motion sensor. The system determines a weight associated with at least one of a plurality of features of the environment in the image based on an estimated motion blur level for the at least one of the features of the environment in the image. The estimated motion blur level is based on the motion data and the image capture setting. The system tracks the features of the environment across a plurality of images (that includes the received image) according to respective weights (that include the determined weight) for the features of the environment across the plurality of images. The system can use the tracked features for mapping the environment and/or determining the pose of the system.

### FIELD

The present disclosure generally relates to imaging and feature tracking. For example, aspects of the present disclosure relate to systems and techniques for voxel-based mapping of an environment based on image data and depth data.

### BACKGROUND

A camera is a device that includes an image sensor that receives light from a scene and captures image data, such as still images or video frames of a video, depicting the scene. A depth sensor is a sensor that obtains depth data indicating how far different points in a scene are from the depth sensor. The depth data can include a depth map, a depth image, a point cloud, or another indication of depth, range, and/or distance. A depth sensor can also be referred to as a range sensor or a distance sensor. Depth sensors can have limitations in the depth data they obtain. For instance, depth data captured by depth sensors can identify depths of points along edges of a surface in a scene without identifying depths for other portions of the surface between the edges.

### BRIEF SUMMARY

Systems and techniques for imaging are described. In some examples, a system receives an image of an environment captured using an image sensor according to an image capture setting, and receives motion data captured using a motion sensor. The system determines a weight associated with at least one of a plurality of features of the environment in the image based on an estimated motion blur level for the at least one of the features of the environment in the image. The estimated motion blur level is based on the motion data and the image capture setting. The system tracks the features of the environment across a plurality of images (that includes the received image) according to respective weights (that include the determined weight) for the features of the environment across the plurality of images. For instance, images in the set of images that were captured when the system was stationary (and corresponding features in those images) can have higher respective weights due to their higher confidence in being accurate (e.g., since the odds of motion blur are low) and thus factor more heavily into the feature tracking, while images in the set of images that were captured when the system was moving can have lower respective weights due to their low confidence in being accurate (e.g., since the odds of motion blur are high) and thus factor less heavily into the feature tracking. The system can use the tracked features for mapping the environment, localizing the system, and/or determining the pose of the system.

According to at least one example, an apparatus for imaging is provided. The apparatus includes a memory and at least one processor (e.g., implemented in circuitry) coupled to the memory. The at least one processor is configured to and can: receive an image of an environment captured using at least one image sensor according to an image capture setting; receive motion data captured using a motion sensor; determine a weight associated with at least one of a plurality of features of the environment in the image based on an estimated motion blur level for the at least one of the features of the environment in the image, wherein the estimated motion blur level is based on the motion data and the image capture setting; and track the features of the environment across a plurality of images according to respective weights for the features of the environment across the plurality of images, wherein the plurality of images includes the image, and wherein the respective weights include the weight.

In another example, a method of imaging is provided. The method includes: $eceiving an image of an environment captured using at least one image sensor according to an image capture setting; receiving motion data captured using a motion sensor; determining a weight associated with at least one of a plurality of features of the environment in the image based on an estimated motion blur level for the at least one of the features of the environment in the image, wherein the estimated motion blur level is based on the motion data and the image capture setting; and tracking the features of the environment across a plurality of images according to respective weights for the features of the environment across the plurality of images, wherein the plurality of images includes the image, and wherein the respective weights include the weight.$

In another example, a non-transitory computer-readable medium is provided that has stored thereon instructions that, when executed by one or more processors, cause the one or more processors to: receive an image of an environment captured using at least one image sensor according to an image capture setting; receive motion data captured using a motion sensor; determine a weight associated with at least one of a plurality of features of the environment in the image based on an estimated motion blur level for the at least one of the features of the environment in the image, wherein the estimated motion blur level is based on the motion data and the image capture setting; and track the features of the environment across a plurality of images according to respective weights for the features of the environment across the plurality of images, wherein the plurality of images includes the image, and wherein the respective weights include the weight.

In another example, an apparatus for imaging is provided. The apparatus includes: means for receiving an image of an environment captured using at least one image sensor according to an image capture setting; means for receiving motion data captured using a motion sensor; means for determining a weight associated with at least one of a plurality of features of the environment in the image based on an estimated motion blur level for the at least one of the features of the environment in the image, wherein the estimated motion blur level is based on the motion data and the image capture setting; and means for tracking the features of the environment across a plurality of images according to respective weights for the features of the environment across the plurality of images, wherein the plurality of images includes the image, and wherein the respective weights include the weight.

In some aspects, one or more of the methods, apparatuses, and computer-readable medium described above further comprise: determining a pose of the apparatus in the environment based on the features tracked in the plurality of images and according to the respective weights for the features of the environment in the plurality of images, wherein the apparatus includes the at least one image sensor and the motion sensor. In some aspects, one or more of the methods, apparatuses, and computer-readable medium described above further comprise: minimizing weighed least squares of reprojection errors according to the respective weights of the features of the environment in the plurality of images to determine the pose of the apparatus in the environment. In some aspects, one or more of the methods, apparatuses, and computer-readable medium described above further comprise: outputting an indication of the pose of the apparatus.

In some aspects, one or more of the methods, apparatuses, and computer-readable medium described above further comprise: mapping the environment based on the features of the environment tracked in the plurality of images and according to the respective weights of the features of the environment for the plurality of images to generate a map of the environment. In some aspects, one or more of the methods, apparatuses, and computer-readable medium described above further comprise: determining a location of the apparatus within the map of the environment based on the features of the environment tracked in the plurality of images and according to the respective weights of the features of the environment for the plurality of images, wherein the apparatus includes the at least one image sensor and the motion sensor. In some aspects, one or more of the methods, apparatuses, and computer-readable medium described above further comprise: outputting at least a portion of the map of the environment.

In some aspects, the respective weights for the features of the environment across the plurality of images correspond to respective error variance values for the plurality of images, further comprising: tracking the features of the environment across the plurality of images according to the respective error variance values for the plurality of images to track the features of the environment across the plurality of images according to the respective weights for the features of the environment across the plurality of images.

In some aspects, one or more of the methods, apparatuses, and computer-readable medium described above further comprise: determining the estimated motion blur level for the at least one of the features of the environment in the image.

In some aspects, the estimated motion blur level for the at least one of the features of the environment in the image is based on a distance from the at least one image sensor to the at least one of the features of the environment, wherein the weight associated with the at least one of the features of the environment in the image is based on the distance from the at least one image sensor to the at least one of the features of the environment.

In some aspects, one or more of the methods, apparatuses, and computer-readable medium described above further comprise: determining a ratio of a constant divided by the estimated motion blur level for the image to determine the weight associated with the image based on the estimated motion blur level for the at least one of the features of the environment in the image.

In some aspects, determining that the estimated motion blur level is less than a predetermined threshold; and setting the weight associated with the at least one of the features of the environment in the image to a predetermined value in response to determining that the estimated motion blur level is less than the predetermined threshold to determine the weight associated with the at least one of the features of the environment in the image based on the estimated motion blur level for the at least one of the features of the environment in the image. In some aspects, the predetermined threshold represents a magnitude of motion blur that is no larger than a pixel.

In some aspects, the estimated motion blur level is an estimated magnitude of motion blur.

In some aspects, the image capture setting includes an exposure time.

In some aspects, the apparatus is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating an example architecture of an image capture and processing system, in accordance with some examples;

FIG. 2 is a block diagram illustrating an example architecture of an imaging system that performs an imaging and feature tracking process, in accordance with some examples;

FIG. 3A is a perspective diagram illustrating a head-mounted display (HMD) that is used as part of an imaging system, in accordance with some examples;

FIG. 3B is a perspective diagram illustrating the head-mounted display (HMD) of FIG. 3A being worn by a user, in accordance with some examples;

FIG. 4A is a perspective diagram illustrating a front surface of a mobile handset that includes front-facing cameras and that can be used as part of an imaging system, in accordance with some examples;

FIG. 4B is a perspective diagram illustrating a rear surface of a mobile handset that includes rear-facing cameras and that can be used as part of an imaging system, in accordance with some examples;

FIG. 5 is a perspective diagram illustrating a vehicle that includes various sensors, in accordance with some examples;

FIG. 6 is a conceptual diagram illustrating feature tracking in an image with motion blur, in accordance with some examples;

FIG. 7 is a block diagram illustrating a process for pose estimation that takes exposure time into account, in accordance with some examples;

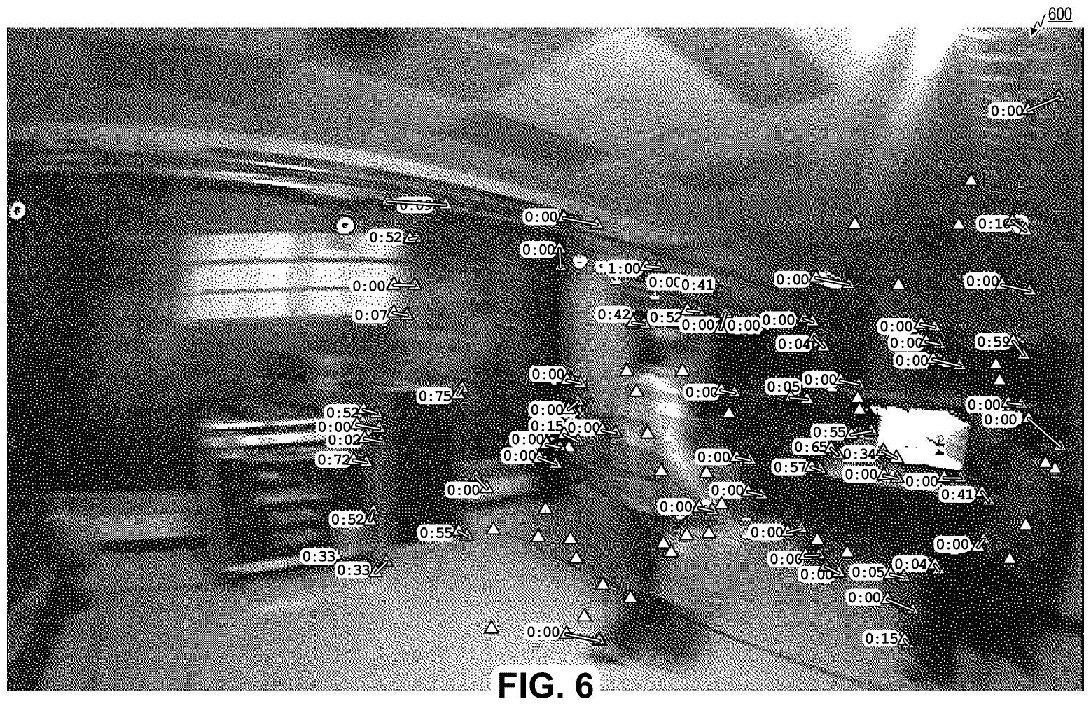

FIG. 6 is a conceptual diagram illustrating feature tracking in an image with motion blur.

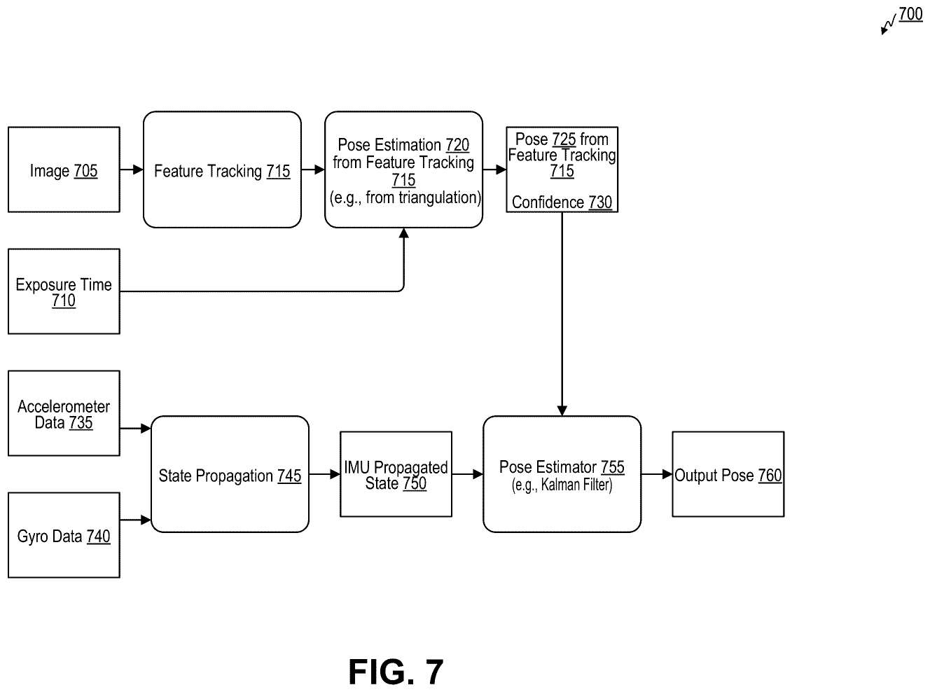

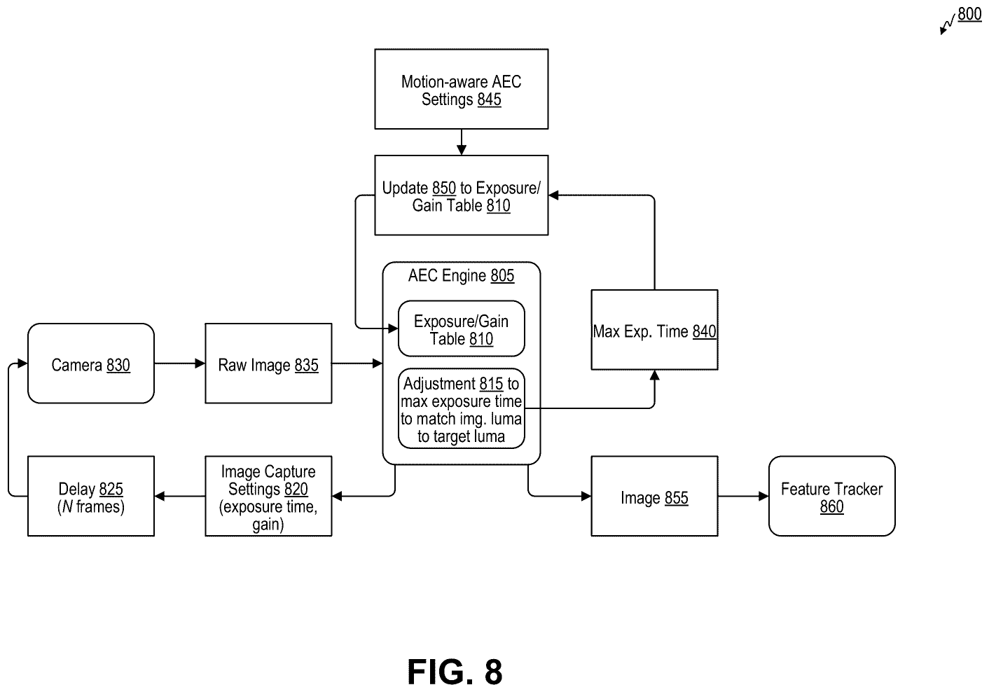

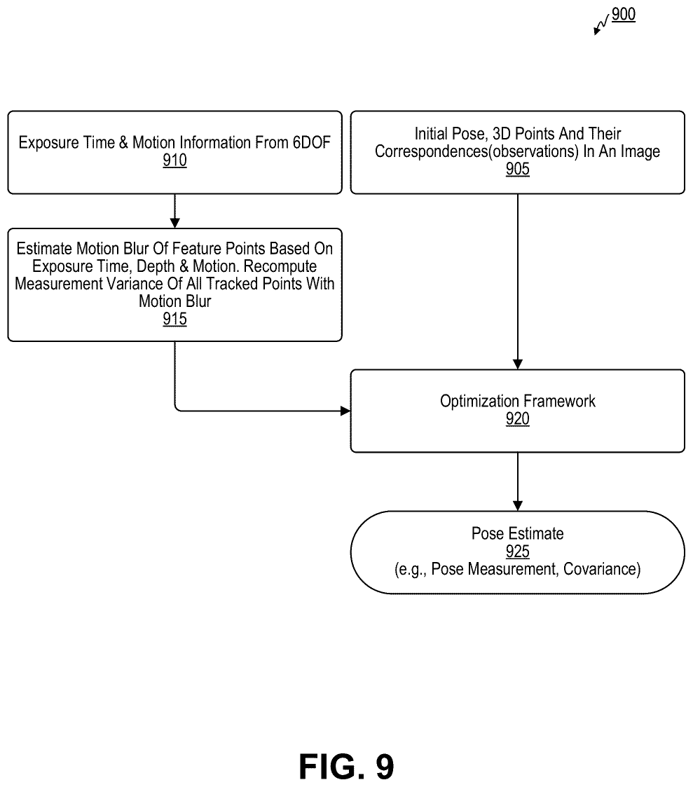

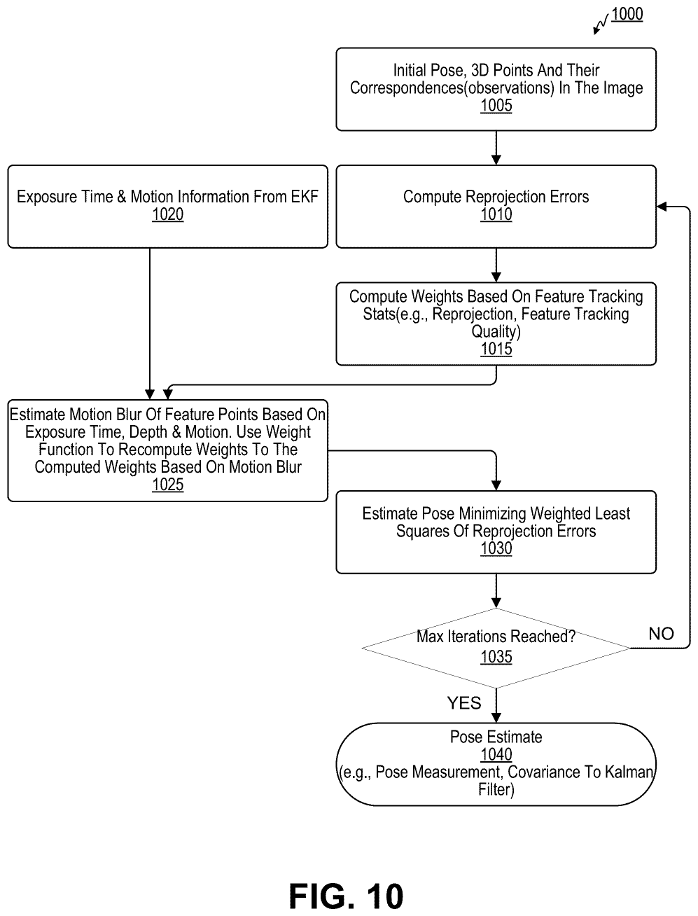

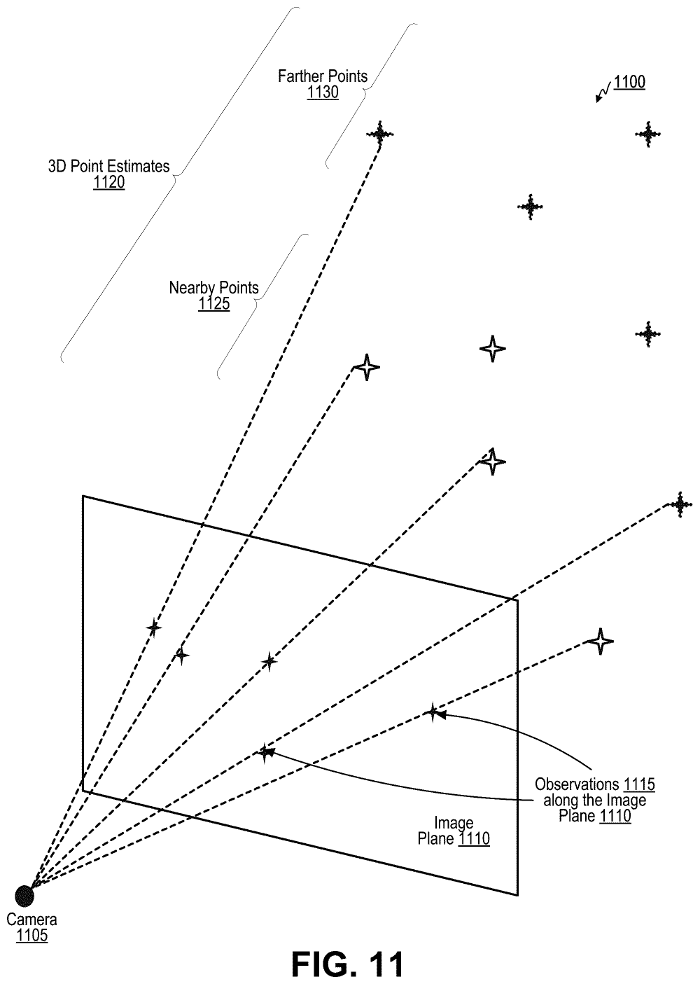

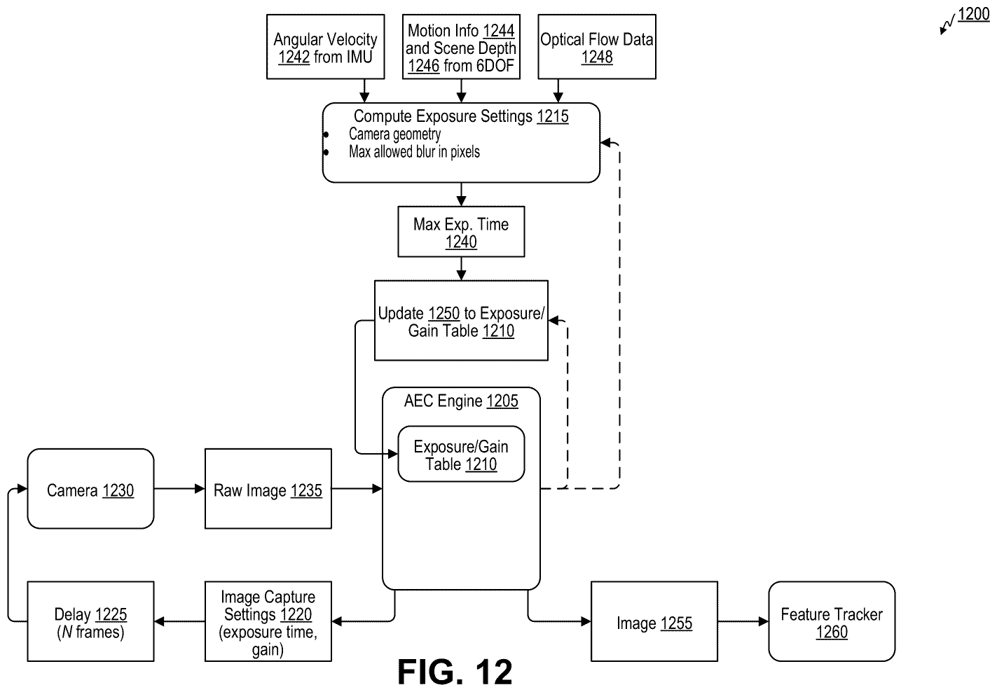

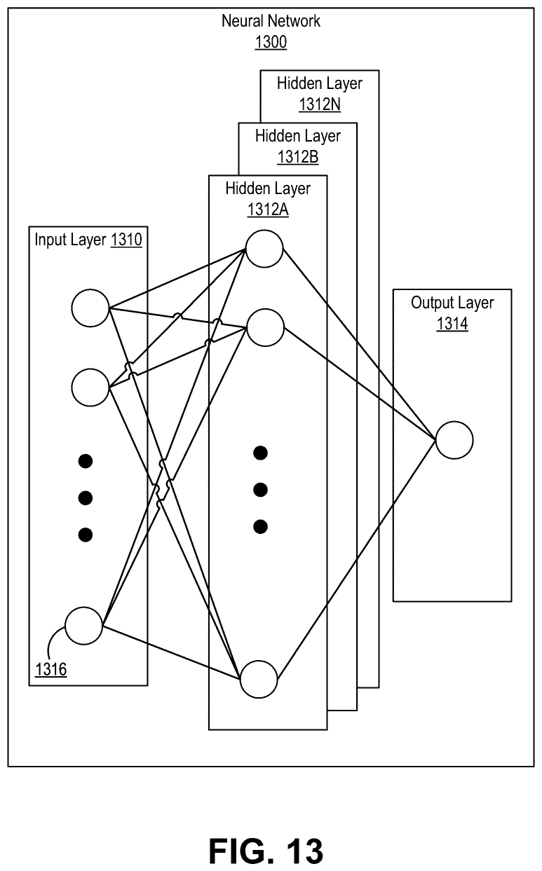

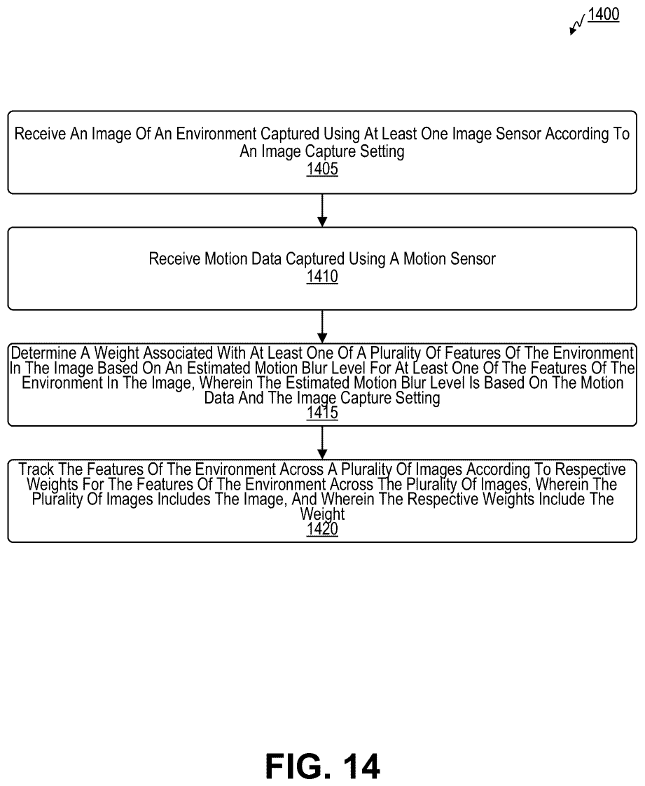

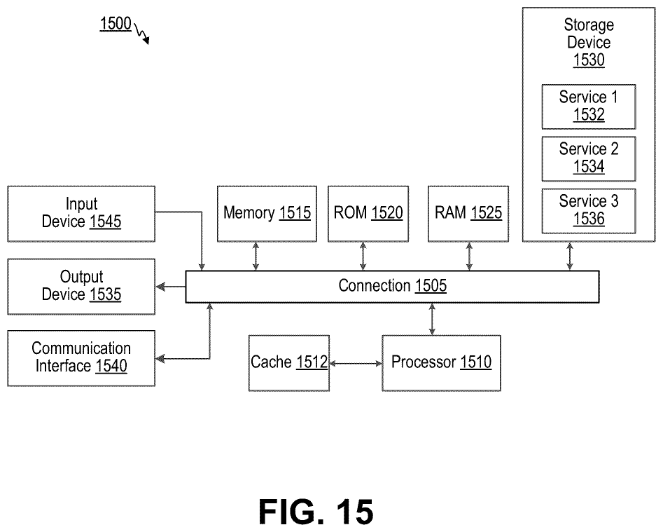

FIG. 7 is a block diagram illustrating a process for pose estimation that takes exposure time into account.

FIG. 8 is a block diagram illustrating a process for automatic exposure control that takes motion data into account, in accordance with some examples;

FIG. 9 is a flow diagram illustrating a process for pose estimation that takes estimated motion blur into account, in accordance with some examples;

FIG. 10 is a flow diagram illustrating a process for pose estimation that takes estimated motion blur into account, in accordance with some examples;

FIG. 11 is a conceptual diagram illustrating image reprojection, in accordance with some examples;

FIG. 12 is a block diagram illustrating a process for automatic exposure control that takes angular velocity, motion information, scene depth, and/or optical flow into account, in accordance with some examples;

FIG. 13 is a block diagram illustrating an example of a neural network that can be used for environment mapping, in accordance with some examples;

FIG. 14 is a flow diagram illustrating an environment mapping process, in accordance with some examples; and

FIG. 15 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

Exposure time refers to how long an aperture of the camera is opened (during image capture) to expose an image sensor of the camera (or, in some cameras, a piece of film) to light from an environment. A longer exposure time can allow the image sensor to receive more light from the environment, causing the image captured by the camera to depict the environment as more brightly-illuminated. However, a longer exposure time can also cause motion blur in the image if the camera is moved (and/or if object(s) in the environment move) during the time while the aperture is open and the image sensor is receiving light during image capture. The motion blur occurs because the image sensor receives light from certain objects in the scene from different directions corresponding to the relative position of the object to the camera at different times during the time while the aperture is open and the image sensor is receiving light during image capture. Shorter exposure times can reduce motion blur in situations where the camera (and/or object(s) in the environment) are moving, but can cause the images captured by the camera to be more dimly-illuminated, and in some cases, more noisy and/or grainy.

A motion sensor is a sensor that obtains data regarding position (e.g., lateral location and/or altitude), orientation (e.g., pitch, yaw, and/or roll), pose (e.g., position and/or orientation), motion (e.g., change in position and/or orientation), speed, velocity, acceleration, or a combination thereof. Motion sensors can include Global Navigation Satellite System (GNSS) receivers, Inertial Measurement Units (IMUs), accelerometers, gyroscopes, gyrometers, barometers, altimeters, or combinations thereof. A motion sensor may be coupled to a device, such as a camera or a device that includes a camera (e.g., a mobile handset, a head-mounted display (HMD) device, a vehicle, a computer, or any other device discussed herein). Where a motion sensor is coupled to a camera, the motion sensor can indicate when the camera is stationary, moving, accelerating, decelerating, turning, and the like.

Imaging and feature tracking systems and techniques are described. In some examples, a system receives an image of an environment captured using an image sensor according to an image capture setting, and receives motion data captured using a motion sensor. The system determines a weight associated with at least one of a plurality of features of the environment in the image based on an estimated motion blur level for the at least one of the features of the environment in the image. The estimated motion blur level is based on the motion data and the image capture setting. The system tracks the features of the environment across a plurality of images (that includes the received image) according to respective weights (that include the determined weight) for the features of the environment across the plurality of images. For instance, images in the set of images that were captured when the system was stationary can have higher respective weights due to their higher confidence in being accurate (e.g., since the odds of motion blur are low) and thus factor more heavily into the feature tracking, while images in the set of images that were captured when the system was moving can have lower respective weights due to their low confidence in being accurate (e.g., since the odds of motion blur are high) and thus factor less heavily into the feature tracking. The system can use the tracked features for mapping the environment, localizing the system, and/or determining the pose of the system.

The imaging and feature tracking systems and techniques described herein provide a number of technical improvements over prior imaging and feature tracking systems. For instance, the imaging and feature tracking systems and techniques described herein can provide more accurate feature tracking by using weights to factor in motion blur in different images compared to feature tracking systems and techniques that do not factor in motion blur. For instance, if the imaging and feature tracking systems and techniques described herein determine that an image is estimated to have a high level of motion blur (e.g., due to a high exposure time and/or motion detected using a motion sensor), the system can choose not to use features extracted from that image for the feature tracking, or to weigh features extracted from that image more lowly than features extracted from an image that is estimated to have a low or nonexistent level of motion blur (e.g., due to a low exposure time and/or lack of motion detected using a motion sensor). The imaging and feature tracking systems and techniques described herein can also be used to set image capture settings, such as exposure time, to reduce estimated levels of motion blur for images to be used in feature tracking, while keeping noise/grain levels sufficiently low to avoid an impact on feature tracking. In this way, the imaging and feature tracking systems and techniques provide for more reliable image capture for feature tracking and for systems that rely on feature tracking, such as imaging systems, pose tracking systems, visual simultaneous localization and mapping (VSLAM) systems, other simultaneous localization and mapping (SLAM) systems, and the like.

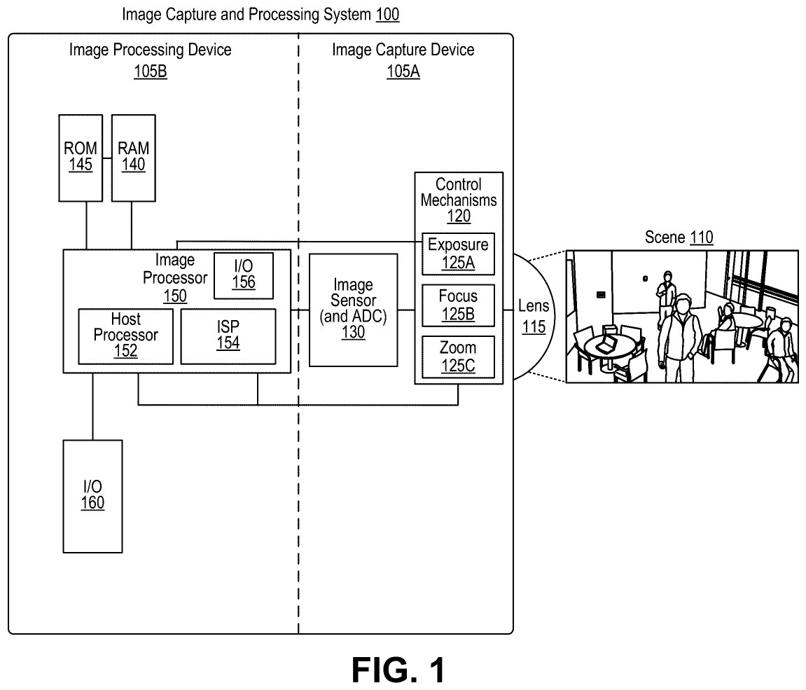

Various aspects of the application will be described with respect to the figures. FIG. 1 is a block diagram illustrating an architecture of an image capture and processing system 100. The image capture and processing system 100 includes various components that are used to capture and process images of one or more scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130. In some examples, the scene 110 is a scene in an environment. In some examples, the image capture and processing system 100 is coupled to, and/or part of, a vehicle 190, and the scene 110 is a scene in an environment around the vehicle 190. In some examples, the scene 110 is a scene of at least a portion of a user. For instance, the scene 110 can be a scene of one or both of the user's eyes, and/or at least a portion of the user's face.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting. In some examples, an exposure setting can be provided to the exposure control mechanism 125A of the control mechanisms 120 from the image processor 150, the host processor 152, the ISP 154, or a combination thereof, for instance as illustrated and discussed further with respect to FIG. 8 and/or FIG. 12.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1510 discussed with respect to the computing system 1500. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140 and/or 1520, read-only memory (ROM) 145 and/or 1525, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1535, any other input devices 1545, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the system 100 and one or more peripheral devices, over which the system 100 may receive data from the one or more peripheral device and/or transmit data to the one or more peripheral devices. The I/O 160 may include one or more wireless transceivers that enable a wireless connection between the system 100 and one or more peripheral devices, over which the system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 1502.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

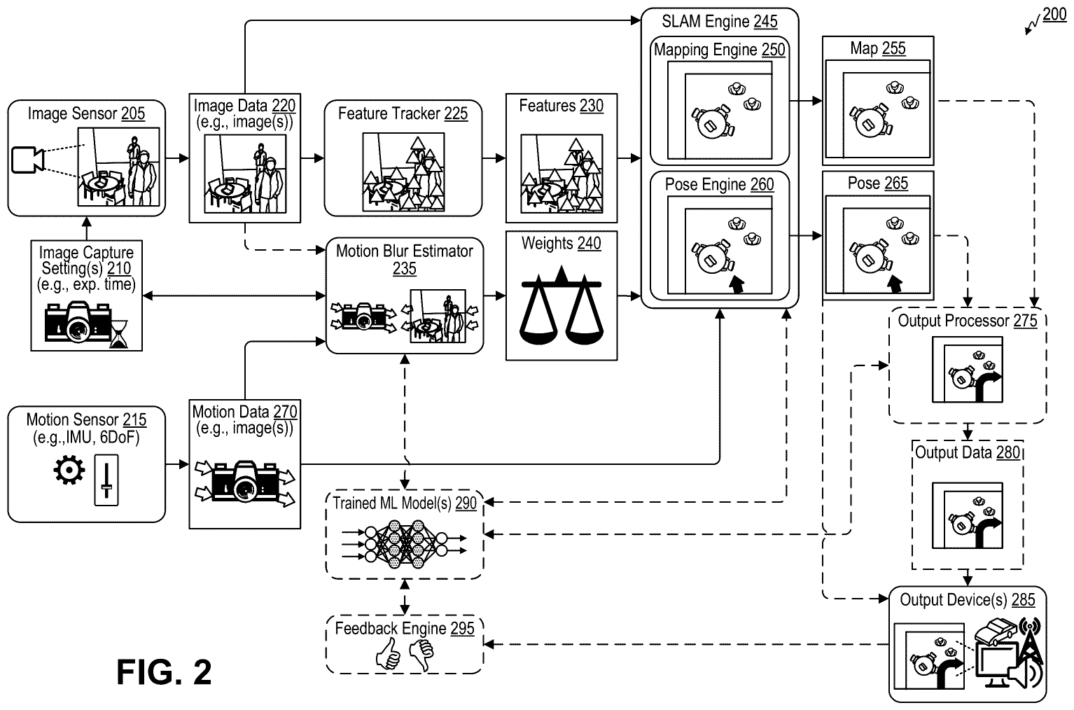

FIG. 2 is a block diagram illustrating an example architecture of an imaging system 200 that performs an imaging and feature tracking process. The imaging system 200 can include, or be part of, at least one of the image capture and processing system 100, the image capture device 105A, the image processing device 105B, the vehicle 190, the HMD 310, the mobile handset 410, the vehicle 510, the imaging system(s) that perform any of processes described herein (e.g., the process 700, the process 800, the process 900, the process 1000, the process 1200, and/or the process 1400), the camera 1105, the neural network 1300, the imaging system(s) that perform any of processes described herein (e.g., process 700, process 900, process 1000, process 1400), the computing system 1500, the processor 1510, or a combination thereof. In some examples, the imaging system 200 can include, or be part of, for instance, one or more laptops, phones, tablet computers, mobile handsets, video game consoles, vehicle computers, vehicles, desktop computers, wearable devices, televisions, media centers, XR systems, head-mounted display (HMD) devices, other types of computing devices discussed herein, or combinations thereof.

The imaging system 200 includes one or more image sensors 205 configured to capture image data 220 (e.g., one or more images, or portion(s) thereof) according to one or more image capture setting(s) 210 (e.g., exposure time and/or any other image capture setting discussed herein). In some examples, the image sensor(s) 205 include one or more image sensors or one or more cameras. In some examples, the image data 220 captured using the image sensor(s) 205 according to the image capture setting(s) 210 includes raw image data, image data, pixel data, image frame(s), raw video data, video data, video frame(s), or a combination thereof. In some examples, at least one of the image sensor(s) 205 can be directed toward a user and/or vehicle (e.g., can face toward the user and/or vehicle), and can thus capture sensor data (e.g., image data) of (e.g., depicting or otherwise representing) at least portion(s) of the user and/or vehicle. In some examples, at least one of the image sensor(s) 205 can be directed away from the user and/or vehicle (e.g., can face away from the user and/or vehicle) and/or toward an environment that the user and/or vehicle is in, and can thus capture sensor data (e.g., image data) of (e.g., depicting or otherwise representing) at least portion(s) of the environment. In some examples, sensor data captured by at least one of the image sensor(s) 205 that is directed away from the user (and/or vehicle) and/or toward the environment can have a field of view (FoV) that includes, is included by, overlaps with, and/or otherwise corresponds to, a FoV of the eyes of the user (and/or a FoV from a location of the vehicle).

Within FIG. 2, a graphic representing the image sensor(s) 205 illustrates the image sensor(s) 205 as including a camera facing an environment with a two people standing, and a table with a laptop surrounded three chairs. Within FIG. 2, a graphic representing the image data 220 illustrates an image depicting of the environment illustrated in the graphic representing the image sensor(s) 205. Within FIG. 2, a graphic representing the image capture setting(s) 210 illustrates an hourglass near a camera, representing exposure time.

The imaging system 200 also includes one or more motion sensors 215 that capture motion data 270. The motion sensor(s) 215 are sensor(s) that capture data regarding position (e.g., lateral location and/or altitude), orientation (e.g., pitch, yaw, and/or roll), pose (e.g., position and/or orientation), motion (e.g., change in position and/or orientation), speed, velocity, acceleration, or a combination thereof. Motion sensors can include Global Navigation Satellite System (GNSS) receivers, Inertial Measurement Units (IMUs), accelerometers, gyroscopes, gyrometers, barometers, altimeters, or combinations thereof. Because the motion sensor(s) 215 and the image sensor(s) 205 are both part of, or coupled to, the imaging system 200, the motion data 270 captured by the motion sensor(s) 215 can indicate when the image sensor(s) 205 of the imaging system 200 are stationary, moving, accelerating, decelerating, turning, or a combination thereof. The motion sensor(s) 215 can also be referred to as positioning sensors, acceleration sensors, orientating sensors, pose sensors, or a combination thereof. In some examples, for instance, the motion data 270 can include angular velocity 1242 from an IMU and/or gyroscope, motion information 1244 and/or scene depth information 1246 from six degrees of freedom (6DoF) sensor(s), optical flow data 1248 from previous image(s) in the image data 220 (and/or previous image data captured by the image sensor(s) 205 before the image data 220), or a combination thereof.

Within FIG. 2, a graphic representing the motion sensor(s) 215 illustrates a gear and a slider representing detection of motion. Within FIG. 2, a graphic representing the motion data 270 illustrates a camera device (which represents the imaging system 200) surrounded by arrows facing diagonally down and to the right, representing that the motion data 270 indicates that the camera device (and thus the imaging system 200) is moving down and to the right in the direction of the arrows.

The imaging system 200 includes a feature tracker 225 that detects, extracts, recognizes, and/or tracks features 230 in the image data 220. The features 230 that the feature tracker 225 detects, extracts, recognizes, and/or tracks in the image data 220 can include, for instance, edges, corners, and blobs. The feature tracker 225 can generate descriptors corresponding to features 230, which may be vector-based indicators of the features 230, such as scale-invariant feature transform (SIFT) descriptors or variants thereof. In some examples, the feature tracker 225 can use one or more trained machine learning (ML) models 290 to detect, extract, recognize, and/or track the features 230 in the image data 220. For instance, the trained ML model(s) 290 can be trained using training data that includes images (such as the image data 220) with features (such as the features 230) previously identified. Within FIG. 2, a graphic representing the feature tracker 225 and the features 230 includes a set of white triangles with black outlines, which represent the features 230, overlaid over an image representing the image data 220.

The imaging system 200 includes a motion blur estimator 235 that estimates a level of motion blur in a given image of the image data 220 based on the image capture setting(s) 210 used for capture of that image and/or the motion data 270 captured by the motion sensor 215 contemporaneously with (e.g., simultaneously with, and/or within a threshold amount of time before or after) capture of the image (of the image data 220). In some examples, the motion blur estimator 235 that estimates the level of motion blur in the given image of the image data 220 based also on image analysis of the given image itself, for instance by using the trained ML model(s) 290 to determine a level of motion blur (or blur more generally) detected in the image itself. In some examples, the motion blur estimator 235 that estimates the level of motion blur in the given image of the image data 220 based also on estimate(s) of the level of motion blur in one or more other images in a series of images in the image data 220, such as one or more images preceding the given image in the series and/or one or more images after the given image in the series. The series of images can be video frames of a video, in which case the image data 220 can include the video frames, the video, or both. Within FIG. 2, a graphic representing the motion blur estimator 235 is illustrated as including the graphic representing the motion data 270 as well as corresponding arrows along the sides of the graphic representing the image data 220 to represent direction(s) of motion blur in the image data 220.

In some examples, the motion blur estimator 235 can also provide feedback to the image capture device that includes the image sensor(s) 205 (e.g., based on the motion data 270 from the motion sensor(s) 215) to modify the image capture setting(s) 210, for instance to reduce exposure time when the estimated level of motion blur exceeds a threshold. For instance, at fast motion speeds, exposure times beyond 2 milliseconds (ms) can produce motion blur, so the motion blur estimator 235 can reduce a maximum allowable exposure time to 2 ms or less, for instance modifying other image capture setting(s) 210 (e.g., ISO, gain) to add brightness to compensate for the shorter exposure time. Once the motion data 270 indicates that the imaging system 200 has slowed down below a threshold speed or is stationary, the motion blur estimator 235 can allow the exposure time to increase again, for instance by increasing a maximum allowable exposure time above 2 ms, without worrying about causing motion blur. In some cases, the exposure time can scale gradually (e.g., linearly, logarithmically, or according to some other relationship) based on changes to the estimated level of motion blur and/or to the motion data 270.

The imaging system 200 (e.g., the motion blur estimator 235 and/or the feature tracker 225) can assign respective weights 240 to different images of the image data 220 based on the respective estimated level of motion blur for the different images of the image data 220. For instance, the imaging system 200 can set the weights 240 so that images of the image data 220 that have a low estimated level motion blur (because they were captured when the imaging system 200 was stationary) can have higher respective weights due to their higher confidence in being accurate. The higher weights in these images mean that features 230 that the feature tracker 225 extracts, detects, and/or recognizes in these images are treated as more important, more accurate, more reliable, and/or more heavily featured (e.g., multiplied by a multiplier greater than 1 and/or with an offset added) in calculations (e.g., by the feature tracker 225 and/or the SLAM engine 245) for feature tracking (e.g., by the feature tracker 225), environment mapping (e.g., by the mapping engine 250), and/or pose estimation (e.g., by the pose engine 260). The imaging system 200 can also set the weights 240 so that, in contrast, images of the image data 220 that have a high estimated level motion blur (because they were captured when the imaging system 200 was in motion) can have lower respective weights due to their lower confidence in being accurate. The lower weights in these images mean that features 230 that the feature tracker 225 extracts, detects, and/or recognizes in these images can be ignored, skipped, deleted, or treated as less important, less accurate, less reliable, and/or less heavily featured (e.g., multiplied by a multiplier less than 1 and/or with an offset subtracted) in calculations (e.g., by the feature tracker 225 and/or the SLAM engine 245) for feature tracking (e.g., by the feature tracker 225), environment mapping (e.g., by the mapping engine 250), and/or pose estimation (e.g., by the pose engine 260). Within FIG. 2, a graphic representing the weights 240 is illustrated as a scale, to indicate that features 230 from different images are treated differently (e.g., ignored, skipped, having their values multiplied by multipliers, having offsets applied, and the like) based on whether the images that those features 230 are detected/extracted/recognized from are found to have a high or low estimated level of motion blur.

In some examples, the imaging system 200 can further assign different weights 240 to different features within a given image (e.g., of the image data 220). If the imaging system 200 undergoes a translational motion, sometimes only parts of an image captured during that motion are affected motion blur, or some parts are more affected by motion blur than others. For instance, typically, parts of the scene that are farther from the image sensor(s) 205 move less within the field of view of the image sensor(s) 205 than parts of the scene that are closer to the image sensor(s) 205. Thus, in some examples, the imaging system 200 can assign weights 240 to the features 230 of an image based on the respective depths of the features 230 (e.g., as detected using the image data 220 and/or depth data from a depth sensor). Depth sensors of the imaging system 200 can include, for instance, Radio Detection and Ranging (RADAR) sensors, Light Detection and Ranging (LIDAR) sensors, Sound Detection and Ranging (SODAR) sensors, Sound Navigation and Ranging (SONAR) sensors, time of flight (ToF) sensors, structured light sensors, stereoscopic cameras, laser rangefinders, or combinations thereof. In some examples, the imaging system 200 can assign weights 240 to the features 230 of an image so that parts of the scene that are farther from the imaging system 200 (e.g., more than a threshold depth) receive higher weights than parts of the scene that are closer to the imaging system 200 (e.g., less than the threshold depth), especially if the estimated level of motion blur is above a threshold level. If the imaging system 200 undergoes a rotational motion exceeding a threshold, the entire image may be blurry due to motion blur, which may cause the imaging system 200 to assign lower weights 240 to the features 230 than for translational motion, and/or to more evenly assign lower weights 240 to the features 230 (e.g., without as much difference between close and far features) than for translational motion.

The imaging system 200 includes a simultaneous localization and mapping (SLAM) engine 245 that receives the features 230 and the corresponding weights 240 from the feature tracker 225 and/or the motion blur estimator 235, and in some cases the image data 220 from the image sensor 205 and/or the motion data 270 from the motion sensor 215. The SLAM engine 245 includes a mapping engine 250 that generates a map 255 of the environment that is depicted in the image data 220 based on the tracking of the features 230 as the imaging system 200 moves throughout different positions in the environment, with features 230 corresponding to high estimated levels of motion blur ignored or factoring less heavily into the mapping calculations based on the weights 240. In some examples, the SLAM engine 245 and/or the mapping engine 250 can use the trained ML model(s) 290 to generate the map 255 based on the features 230 and the weights 240, and in some cases the image data 220 and/or the motion data 270 as well. For instance, the trained ML model(s) 290 can be trained using training data that includes a pre-generated map of an environment as well as images, features extracted from the images, weights for the features, and/or motion data from the device that captured the images. Within FIG. 2, a graphic representing the mapping engine 250 and the map 255 is illustrated as a top-down view of the environment that is depicted in the graphic representing the image data 220, with the table, the chairs, the laptop, and the two people visible.

The SLAM engine 245 of the imaging system 200 also includes a pose engine 260 that estimates a pose 265 of the imaging system 200 (e.g., of the image sensor 205 and/or the motion sensor 215), for instance a pose 265 of the imaging system 200 relative to the environment (and/or the map 255 thereof), based on the features 230 and the weights 240, and in some cases the image data 220 and/or the motion data 270. The pose engine 260 can ignore features 230 corresponding to high estimated levels of motion blur, or factoring these features 230 less heavily into the pose estimation calculations based on the weights 240. In some examples, the SLAM engine 245 and/or the pose engine 260 can use the trained ML model(s) 290 to estimate the pose 265 based on the features 230 and the weights 240, and in some cases the image data 220 and/or the motion data 270 as well. For instance, the trained ML model(s) 290 can be trained using training data that includes a pre-determined pose of an environment as well as image(s) of an environment captured by a device at the pre-determined pose, features extracted from the image(s), weights for the features, and/or motion data from the device that captured the image(s). Within FIG. 2, a graphic representing the pose engine 260 and the pose 265 is illustrated as an arrow overlaid over the graphic representing the map 255 representing the position of the image sensor 205 to capture the image data 220 as depicted in the graphic representing the image data 220.

In some examples, the imaging system 200 includes an output processor 275 that generates output data 280 based on the map 255, the pose 265, the features 230, the weights 240, the image data 220, the motion data 270, or a combination thereof. In some examples, the output data 280 includes the map 255, the pose 265, the features 230, the weights 240, the image data 220, the motion data 270, or a combination thereof. In some examples, the output data 280 includes information or image(s) derived from, or otherwise based on, the map 255, the pose 265, the features 230, the weights 240, the image data 220, the motion data 270, or a combination thereof. For instance, in some examples, the output data 280 includes a route through the map 255 (and/or directions for following the route) along a path that includes the pose 265 (e.g., from the pose 265 to a destination), an augmented reality (AR) view based on the map 255 and/or pose 265 and/or image data 220, a virtual reality (VR) view based on the map 255 and/or pose 265 and/or image data 220, a mixed reality (MR) view based on the map 255 and/or pose 265 and/or image data 220, an extended reality (XR) view based on the map 255 and/or pose 265 and/or image data 220, or a combination thereof.

In some examples, the output processor 275 can use the trained ML model(s) 290 to generate the output data 280 based on the map 255, the pose 265, the features 230 the weights 240, the image data 220, and/or the motion data 270. For instance, the trained ML model(s) 290 can be trained using training data that includes a pre-generated output data as well as corresponding map(s), pose(s), features, weights, image data, and/or the motion data. Within FIG. 2, a graphic representing the output processor 275 and the output data 280 is illustrated as a route overlaid over the graphic representing the map 255, the route including the position of the arrow representing the pose the graphic representing the pose 265.

The imaging system 200 includes one or more output devices 285 configured to output the output data 280 and/or the pose 265 and/or the map 255. The output device(s) 285 can include one or more visual output devices, such as display(s) or connector(s) therefor. The output device(s) 285 can include one or more audio output devices, such as speaker(s), headphone(s), and/or connector(s) therefor. The output device(s) 285 can include one or more of the output device 1535 and/or of the communication interface 1540 of the computing system 1500. In some examples, the imaging system 200 causes the display(s) of the output device(s) 285 to display the output data 280 and/or the pose 265 and/or the map 255.

In some examples, the output device(s) 285 include one or more transceivers. The transceiver(s) can include wired transmitters, receivers, transceivers, or combinations thereof. The transceiver(s) can include wireless transmitters, receivers, transceivers, or combinations thereof. The transceiver(s) can include one or more of the output device 1535 and/or of the communication interface 1540 of the computing system 1500. In some examples, the imaging system 200 causes the transceiver(s) to send, to a recipient device, the output data 280 and/or the pose 265 and/or the map 255. In some examples, the recipient device can include an HMD 310, a mobile handset 410, a vehicle 510, a computing system 1500, or a combination thereof. In some examples, the recipient device can include a display, and the data sent to the recipient device from the transceiver(s) of the output device(s) 285 can cause the display of the recipient device to display the output data 280 and/or the pose 265 and/or the map 255.

In some examples, the display(s) of the output device(s) 285 of the imaging system 200 function as optical “see-through” display(s) that allow light from the real-world environment (scene) around the imaging system 200 to traverse (e.g., pass) through the display(s) of the output device(s) 285 to reach one or both eyes of the user. For example, the display(s) of the output device(s) 285 can be at least partially transparent, translucent, light-permissive, light-transmissive, or a combination thereof. In an illustrative example, the display(s) of the output device(s) 285 includes a transparent, translucent, and/or light-transmissive lens and a projector. The display(s) of the output device(s) 285 of can include a projector that projects virtual content (e.g., the output data 280 and/or the pose 265 and/or the map 255) onto the lens. The lens may be, for example, a lens of a pair of glasses, a lens of a goggle, a contact lens, a lens of a head-mounted display (HMD) device, or a combination thereof. Light from the real-world environment passes through the lens and reaches one or both eyes of the user. The projector can project virtual content (e.g., the output data 280 and/or the pose 265 and/or the map 255) onto the lens, causing the virtual content to appear to be overlaid over the user's view of the environment from the perspective of one or both of the user's eyes. In some examples, the projector can project the virtual content onto the onto one or both retinas of one or both eyes of the user rather than onto a lens, which may be referred to as a virtual retinal display (VRD), a retinal scan display (RSD), or a retinal projector (RP) display.

In some examples, the display(s) of the output device(s) 285 of the imaging system 200 are digital “pass-through” display that allow the user of the imaging system 200 and/or a recipient device to see a view of an environment by displaying the view of the environment on the display(s) of the output device(s) 285. The view of the environment that is displayed on the digital pass-through display can be a view of the real-world environment around the imaging system 200, for example based on sensor data (e.g., images, videos, depth images, point clouds, other depth data, or combinations thereof) captured by one or more environment-facing sensors of the image sensor(s) 205 (e.g., the output data 280 and/or the pose 265 and/or the map 255). The view of the environment that is displayed on the digital pass-through display can be a virtual environment (e.g., as in VR), which may in some cases include elements that are based on the real-world environment (e.g., boundaries of a room). The view of the environment that is displayed on the digital pass-through display can be an augmented environment (e.g., as in AR) that is based on the real-world environment. The view of the environment that is displayed on the digital pass-through display can be a mixed environment (e.g., as in MR) that is based on the real-world environment. The view of the environment that is displayed on the digital pass-through display can include virtual content (e.g., the output data 280 and/or the pose 265 and/or the map 255) overlaid over other otherwise incorporated into the view of the environment.

Within FIG. 2, a graphic representing the output device(s) 285 illustrates a display, a speaker, a wireless transceiver, and a vehicle, outputting graphics representing the output data 280 and/or the pose 265 and/or the map 255 using the display, the speaker, the wireless transceiver, and/or a system associated with the vehicle (e.g., controlling computing systems such as an ADAS of the vehicle, IVI systems of the vehicle, control systems of the vehicle, or a combination thereof).

The trained ML model(s) 290 can include one or more neural network (NNs) (e.g., neural network 1300), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. Within FIG. 2, a graphic representing the trained ML model(s) 290 illustrates a set of circles connected to another. Each of the circles can represent a node (e.g., node 1316), a neuron, a perceptron, a layer, a portion thereof, or a combination thereof. The circles are arranged in columns. The leftmost column of white circles represent an input layer (e.g., input layer 1310). The rightmost column of white circles represent an output layer (e.g., output layer 1314). Two columns of shaded circled between the leftmost column of white circles and the rightmost column of white circles each represent hidden layers (e.g., hidden layers 1312A-1312N).

In some examples, the imaging system 200 includes a feedback engine 295 of the imaging system 200. The feedback engine 295 can detect feedback received from a user interface of the imaging system 200. The feedback may include feedback on output(s) of the output device(s) 285 (e.g., the output data 280 and/or the pose 265 and/or the map 255). The feedback engine 295 can detect feedback about one subsystem of the imaging system 200 received from another subsystem of the imaging system 200, for instance whether one subsystem decides to use data from the other subsystem or not. For example, the feedback engine 295 can detect whether or not the SLAM engine 245 decides to use the features 230 and/or the weights 240 generated by the feature tracker 225 and/or the motion blur estimator 235 based on whether or not the features 230 and/or the weights 240 work for the needs of the SLAM engine 245 for generating the map 255 and/or the pose 265, and can provide feedback as to the functioning of the trained ML model(s) 290 as used by the SLAM engine 245 to generate the map 255 and/or the pose 265. Similarly, the feedback engine 295 can detect whether or not the output processor 275 decides to use the map 255 and/or the pose 265 generated by the SLAM engine 245 based on whether or not the map 255 and/or the pose 265 works for the needs of the output processor 275 for generating the output data 280, and can provide feedback as to the functioning of the trained ML model(s) 290 as used by the output processor 275 to generate the output data 280. Similarly, the feedback engine 295 can detect whether or not the output device(s) 285 decides to output the output data 280 and/or the pose 265 and/or the map 255 generated by the output processor 275 and/or the SLAM engine 245 based on whether or not the output data 280 and/or the pose 265 and/or the map 255 works for the needs of the output device(s) 285 for outputting, and can provide feedback as to the functioning of the trained ML model(s) 290 as used by the SLAM engine 245 and/or the output processor 275 to generate the pose 265 and/or the map 255 and/or the output data 280.

The feedback received by the feedback engine 295 can be positive feedback or negative feedback. For instance, if the one subsystem of the imaging system 200 uses data from another subsystem of the imaging system 200, or if positive feedback from a user is received through a user interface or from one of the subsystems, the feedback engine 295 can interpret this as positive feedback. If the one subsystem of the imaging system 200 declines to use data from another subsystem of the imaging system 200, or if negative feedback from a user is received through a user interface or from one of the subsystems, the feedback engine 295 can interpret this as negative feedback. Positive feedback can also be based on attributes of the sensor data from sensor(s) (e.g., the image sensor(s) 205, the motion sensor(s) 215, and/or other sensor(s) such as microphone(s) or depth sensor(s)) of the imaging system 200, such as detection of a user smiling, laughing, nodding, saying a positive statement (e.g., “yes,” “confirmed,” “okay,” “next,” “confirmed,” “approved,” “I like this”), or otherwise positively reacting to an output of one of the subsystems described herein, or an indication thereof. Negative feedback can also be based on attributes of the sensor data from the image sensor(s) 205, such as the user frowning, crying, shaking their head (e.g., in a “no” motion), saying a negative statement (e.g., “no,” “negative,” “bad,” “not this,” “I hate this,” “this doesn't work,” “this isn't what I wanted”), or otherwise negatively reacting to an output of one of the subsystems described herein, or an indication thereof.

In some examples, the feedback engine 295 provides the feedback to the trained ML model(s) 290, and/or to one or more subsystems of the imaging system 200 that use the that use the trained ML model(s) 290 (e.g., the feature tracker 225, the motion blur estimator 235, the SLAM engine 245, the mapping engine 250, the pose engine 260, the output processor 275, and/or the trained ML model(s) 290) as training data to update the one or more trained ML model(s) 290 of the imaging system 200. Positive feedback can be used to strengthen and/or reinforce weights associated with the outputs of the ML system(s) and/or the trained ML model(s) 290, and/or to weaken or remove other weights other than those associated with the outputs of the ML system(s) and/or the trained ML model(s) 290. Negative feedback can be used to weaken and/or remove weights associated with the outputs of the ML system(s) and/or the trained ML model(s) 290, and/or to strengthen and/or reinforce other weights other than those associated with the outputs of the ML system(s) and/or the trained ML model(s) 290.

It should be understood that references herein to the image sensor(s) 205, and other sensors described herein, as images sensors should be understood to also include other types of sensors that can produce outputs in image form, such as depth sensors that produce depth maps, depth images, and/or point clouds (e.g., semi-dense point clouds) that can be expressed in image form and/or rendered images of 3D models (e.g., RADAR, LIDAR, SONAR, SODAR, TOF, structured light). It should be understood that references herein to image data, and/or to images, produced by such sensors can include any sensor data that can be output in image form, such as depth maps, depth images, and/or point clouds (e.g., semi-dense point clouds) that can be expressed in image form, and/or rendered images of 3D models.

In some examples, certain elements of the imaging system 200 (e.g., the image sensor(s) 205, the motion sensor(s) 215, the feature tracker 225, the motion blur estimator 235, the SLAM engine 245, the mapping engine 250, the pose engine 260, the output processor 275, the trained ML model(s) 290, the feedback engine 295, or a combination thereof) include a software element, such as a set of instructions corresponding to a program (e.g., a hardware driver, a user interface (UI), an application programming interface (API), an operating system (OS), and the like), that is run on a processor such as the processor 1510 of the computing system 1500, the image processor 150, the host processor 152, the ISP 154, a microcontroller, a controller, or a combination thereof. In some examples, one or more of these elements of the imaging system 200 can include one or more hardware elements, such as a specialized processor (e.g., the processor 1510 of the computing system 1500, the image processor 150, the host processor 152, the ISP 154, a microcontroller, a controller, or a combination thereof). In some examples, one or more of these elements of the imaging system 200 can include a combination of one or more software elements and one or more hardware elements.

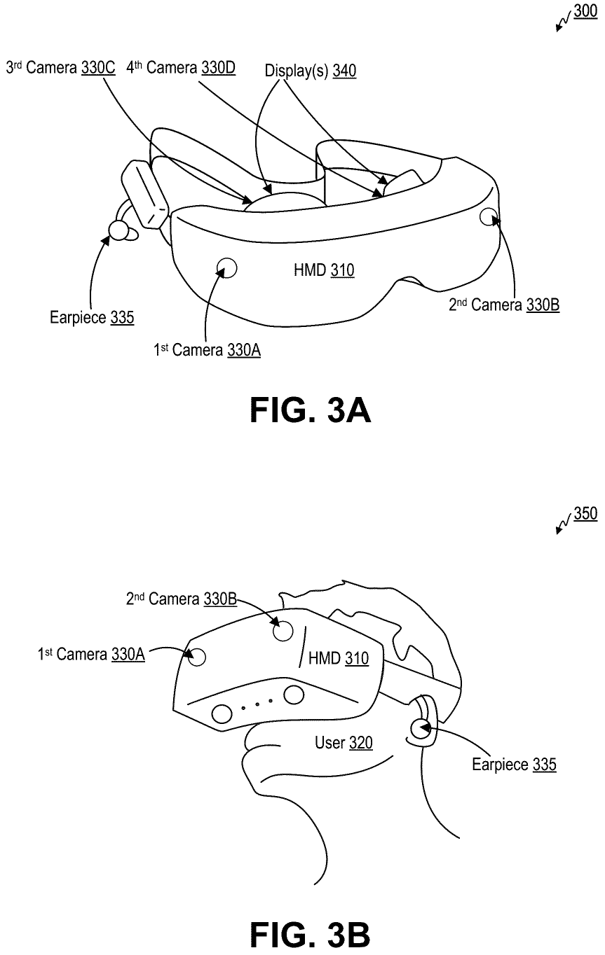

FIG. 3A is a perspective diagram 300 illustrating a head-mounted display (HMD) 310 that is used as part of an imaging system 200. The HMD 310 may be, for example, an augmented reality (AR) headset, a virtual reality (VR) headset, a mixed reality (MR) headset, an extended reality (XR) headset, or some combination thereof. The HMD 310 may be an example of an imaging system 200. The HMD 310 includes a first camera 330A and a second camera 330B along a front portion of the HMD 310. The first camera 330A and the second camera 330B may be examples of the image sensor(s) 205 of the imaging systems 200. The HMD 310 includes a third camera 330C and a fourth camera 330D facing the eye(s) of the user as the eye(s) of the user face the display(s) 340. The third camera 330C and the fourth camera 330D may be examples of the image sensor(s) 205 of the imaging systems 200. In some examples, the HMD 310 may only have a single camera with a single image sensor. In some examples, the HMD 310 may include one or more additional cameras in addition to the first camera 330A, the second camera 330B, third camera 330C, and the fourth camera 330D. In some examples, the HMD 310 may include one or more additional sensors in addition to the first camera 330A, the second camera 330B, third camera 330C, and the fourth camera 330D, which may also include other types of image sensor(s) 205 of the imaging system 200. In some examples, the first camera 330A, the second camera 330B, third camera 330C, and/or the fourth camera 330D may be examples of the image capture and processing system 100, the image capture device 105A, the image processing device 105B, or a combination thereof. In some examples, any of the first camera 330A, the second camera 330B, third camera 330C, and/or the fourth camera 330D can be, or can include, depth sensors.

The HMD 310 may include one or more displays 340 that are visible to a user 320 wearing the HMD 310 on the user 320's head. The one or more displays 340 of the HMD 310 can be examples of the one or more displays of the output device(s) 285 of the imaging systems 200. In some examples, the HMD 310 may include one display 340 and two viewfinders. The two viewfinders can include a left viewfinder for the user 320's left eye and a right viewfinder for the user 320's right eye. The left viewfinder can be oriented so that the left eye of the user 320 sees a left side of the display. The right viewfinder can be oriented so that the right eye of the user 320 sees a right side of the display. In some examples, the HMD 310 may include two displays 340, including a left display that displays content to the user 320's left eye and a right display that displays content to a user 320's right eye. The one or more displays 340 of the HMD 310 can be digital “pass-through” displays or optical “see-through” displays.

The HMD 310 may include one or more earpieces 335, which may function as speakers and/or headphones that output audio to one or more ears of a user of the HMD 310, and may be examples of output device(s) 285. One earpiece 335 is illustrated in FIGS. 3A and 3B, but it should be understood that the HMD 310 can include two earpieces, with one earpiece for each ear (left ear and right ear) of the user. In some examples, the HMD 310 can also include one or more microphones (not pictured). The one or more microphones can be examples of the image sensor(s) 205 of the imaging systems 200. In some examples, the audio output by the HMD 310 to the user through the one or more earpieces 335 may include, or be based on, audio recorded using the one or more microphones.

FIG. 3B is a perspective diagram 350 illustrating the head-mounted display (HMD) of FIG. 3A being worn by a user 320. The user 320 wears the HMD 310 on the user 320's head over the user 320's eyes. The HMD 310 can capture images with the first camera 330A and the second camera 330B. In some examples, the HMD 310 displays one or more output images toward the user 320's eyes using the display(s) 340. In some examples, the output images can include the output data 280 and/or the pose 265 and/or the map 255. The output images can be based on the images captured by the first camera 330A and the second camera 330B (e.g., the image data 220), for example with the virtual content (e.g., the output data 280 and/or the pose 265 and/or the map 255) overlaid. The output images may provide a stereoscopic view of the environment, in some cases with the virtual content overlaid and/or with other modifications. For example, the HMD 310 can display a first display image to the user 320's right eye, the first display image based on an image captured by the first camera 330A. The HMD 310 can display a second display image to the user 320's left eye, the second display image based on an image captured by the second camera 330B. For instance, the HMD 310 may provide overlaid virtual content in the display images overlaid over the images captured by the first camera 330A and the second camera 330B. The third camera 330C and the fourth camera 330D can capture images of the eyes of the before, during, and/or after the user views the display images displayed by the display(s) 340. This way, the sensor data from the third camera 330C and/or the fourth camera 330D can capture reactions to the virtual content by the user's eyes (and/or other portions of the user). An earpiece 335 of the HMD 310 is illustrated in an ear of the user 320. The HMD 310 may be outputting audio to the user 320 through the earpiece 335 and/or through another earpiece (not pictured) of the HMD 310 that is in the other ear (not pictured) of the user 320.

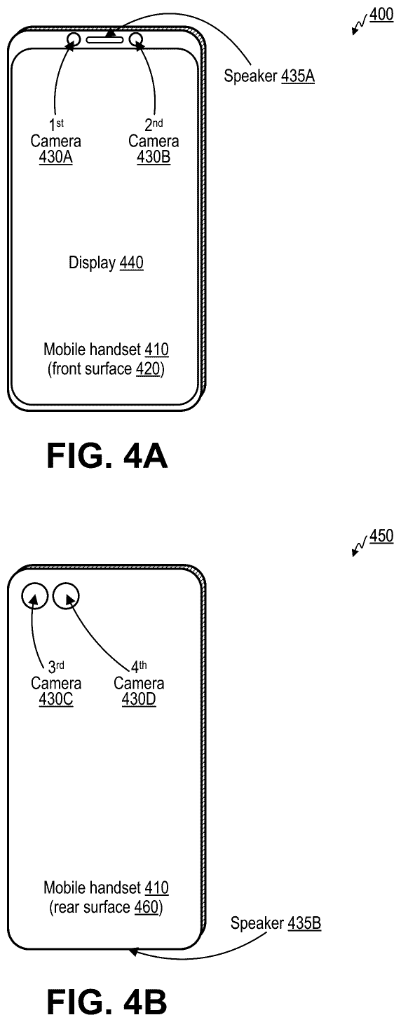

FIG. 4A is a perspective diagram 400 illustrating a front surface of a mobile handset 410 that includes front-facing cameras and can be used as part of an imaging system 200. The mobile handset 410 may be an example of an imaging system 200. The mobile handset 410 may be, for example, a cellular telephone, a satellite phone, a portable gaming console, a music player, a health tracking device, a wearable device, a wireless communication device, a laptop, a mobile device, any other type of computing device or computing system discussed herein, or a combination thereof.

The front surface 420 of the mobile handset 410 includes a display 440. The front surface 420 of the mobile handset 410 includes a first camera 430A and a second camera 430B. The first camera 430A and the second camera 430B may be examples of the image sensor(s) 205 of the imaging systems 200. The first camera 430A and the second camera 430B can face the user, including the eye(s) of the user, while content (e.g., the output data 280 and/or the pose 265 and/or the map 255) is displayed on the display 440. The display 440 may be an example of the display(s) of the output device(s) 285 of the imaging systems 200.

The first camera 430A and the second camera 430B are illustrated in a bezel around the display 440 on the front surface 420 of the mobile handset 410. In some examples, the first camera 430A and the second camera 430B can be positioned in a notch or cutout that is cut out from the display 440 on the front surface 420 of the mobile handset 410. In some examples, the first camera 430A and the second camera 430B can be under-display cameras that are positioned between the display 440 and the rest of the mobile handset 410, so that light passes through a portion of the display 440 before reaching the first camera 430A and the second camera 430B. The first camera 430A and the second camera 430B of the perspective diagram 400 are front-facing cameras. The first camera 430A and the second camera 430B face a direction perpendicular to a planar surface of the front surface 420 of the mobile handset 410. The first camera 430A and the second camera 430B may be two of the one or more cameras of the mobile handset 410. In some examples, the front surface 420 of the mobile handset 410 may only have a single camera.

In some examples, the display 440 of the mobile handset 410 displays one or more output images toward the user using the mobile handset 410. In some examples, the output images can include the output data 280 and/or the pose 265 and/or the map 255. The output images can be based on the images (e.g., the image data 220) captured by the first camera 430A, the second camera 430B, the third camera 430C, and/or the fourth camera 430D, for example with the virtual content (e.g., the output data 280 and/or the pose 265 and/or the map 255) overlaid.

In some examples, the front surface 420 of the mobile handset 410 may include one or more additional cameras in addition to the first camera 430A and the second camera 430B. The one or more additional cameras may also be examples of the image sensor(s) 205 of the imaging systems 200. In some examples, the front surface 420 of the mobile handset 410 may include one or more additional sensors in addition to the first camera 430A and the second camera 430B. The one or more additional sensors may also be examples of the image sensor(s) 205 of the imaging systems 200. In some cases, the front surface 420 of the mobile handset 410 includes more than one display 440. The one or more displays 440 of the front surface 420 of the mobile handset 410 can be examples of the display(s) of the output device(s) 285 of the imaging systems 200. For example, the one or more displays 440 can include one or more touchscreen displays.

The mobile handset 410 may include one or more speakers 435A and/or other audio output devices (e.g., earphones or headphones or connectors thereto), which can output audio to one or more ears of a user of the mobile handset 410. One speaker 435A is illustrated in FIG. 4A, but it should be understood that the mobile handset 410 can include more than one speaker and/or other audio device. In some examples, the mobile handset 410 can also include one or more microphones (not pictured). The one or more microphones can be examples of the image sensor(s) 205 of the imaging systems 200. In some examples, the mobile handset 410 can include one or more microphones along and/or adjacent to the front surface 420 of the mobile handset 410, with these microphones being examples of the image sensor(s) 205 of the imaging systems 200. In some examples, the audio output by the mobile handset 410 to the user through the one or more speakers 435A and/or other audio output devices may include, or be based on, audio recorded using the one or more microphones.

FIG. 4B is a perspective diagram 450 illustrating a rear surface 460 of a mobile handset that includes rear-facing cameras and that can be used as part of an imaging system 200. The mobile handset 410 includes a third camera 430C and a fourth camera 430D on the rear surface 460 of the mobile handset 410. The third camera 430C and the fourth camera 430D of the perspective diagram 450 are rear-facing. The third camera 430C and the fourth camera 430D may be examples of the image sensor(s) 205 of the imaging systems 200 of FIG. 2. The third camera 430C and the fourth camera 430D face a direction perpendicular to a planar surface of the rear surface 460 of the mobile handset 410.

The third camera 430C and the fourth camera 430D may be two of the one or more cameras of the mobile handset 410. In some examples, the rear surface 460 of the mobile handset 410 may only have a single camera. In some examples, the rear surface 460 of the mobile handset 410 may include one or more additional cameras in addition to the third camera 430C and the fourth camera 430D. The one or more additional cameras may also be examples of the image sensor(s) 205 of the imaging systems 200. In some examples, the rear surface 460 of the mobile handset 410 may include one or more additional sensors in addition to the third camera 430C and the fourth camera 430D. The one or more additional sensors may also be examples of the image sensor(s) 205 of the imaging systems 200. In some examples, the first camera 430A, the second camera 430B, third camera 430C, and/or the fourth camera 430D may be examples of the image capture and processing system 100, the image capture device 105A, the image processing device 105B, or a combination thereof. In some examples, any of the first camera 430A, the second camera 430B, third camera 430C, and/or the fourth camera 430D can be, or can include, depth sensors.

The mobile handset 410 may include one or more speakers 435B and/or other audio output devices (e.g., earphones or headphones or connectors thereto), which can output audio to one or more ears of a user of the mobile handset 410. One speaker 435B is illustrated in FIG. 4B, but it should be understood that the mobile handset 410 can include more than one speaker and/or other audio device. In some examples, the mobile handset 410 can also include one or more microphones (not pictured). The one or more microphones can be examples of the image sensor(s) 205 of the imaging systems 200. In some examples, the mobile handset 410 can include one or more microphones along and/or adjacent to the rear surface 460 of the mobile handset 410, with these microphones being examples of the image sensor(s) 205 of the imaging systems 200. In some examples, the audio output by the mobile handset 410 to the user through the one or more speakers 435B and/or other audio output devices may include, or be based on, audio recorded using the one or more microphones.

The mobile handset 410 may use the display 440 on the front surface 420 as a pass-through display. For instance, the display 440 may display output images, such as the output data 280 and/or the pose 265 and/or the map 255. The output images can be based on the images (e.g. the image data 220) captured by the third camera 430C and/or the fourth camera 430D, for example with the virtual content (e.g., the output data 280 and/or the pose 265 and/or the map 255) overlaid. The first camera 430A and/or the second camera 430B can capture images of the user's eyes (and/or other portions of the user) before, during, and/or after the display of the output images with the virtual content on the display 440. This way, the sensor data from the first camera 430A and/or the second camera 430B can capture reactions to the virtual content by the user's eyes (and/or other portions of the user).

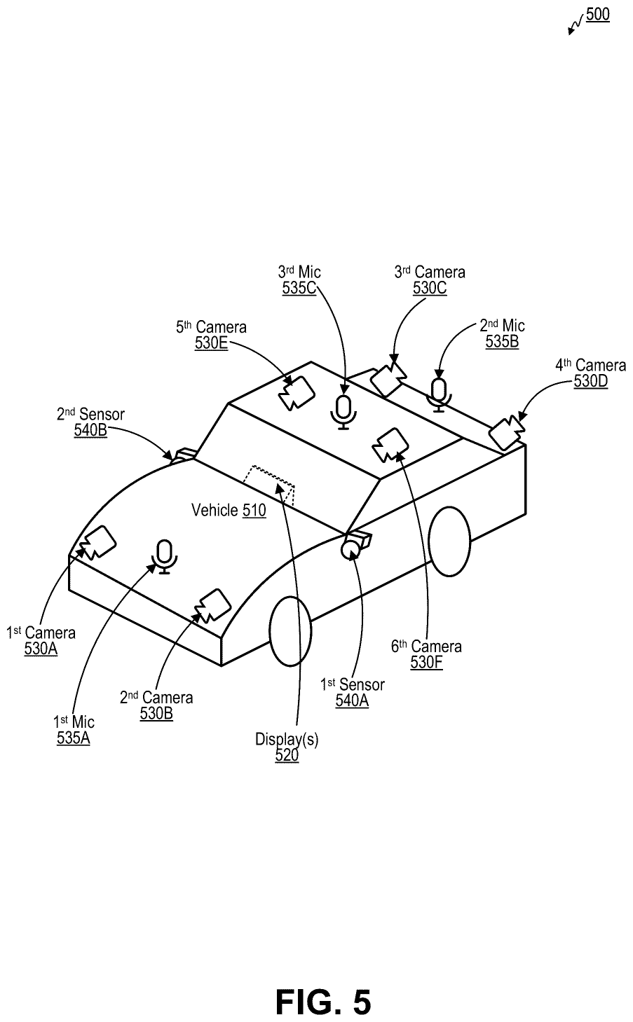

FIG. 5 is a perspective diagram 500 illustrating a vehicle 510 that includes various sensors. The vehicle 510 may be an example of an imaging system 200. The vehicle 510 is illustrated as an automobile, but may be, for example, an automobile, a truck, a bus, a train, a ground-based vehicle, an airplane, a helicopter, an aircraft, an aerial vehicle, a boat, a submarine, a watercraft, an underwater vehicle, a hovercraft, another type of vehicle discussed herein, or a combination thereof. In some examples, the vehicle may be at least partially controlled and/or used with sub-systems of the vehicle 510, such as ADAS of the vehicle 510, IVI systems of the vehicle 510, control systems of the vehicle 510, a vehicle electronic control unit (ECU) 630 of the vehicle 510, or a combination thereof.

The vehicle 510 includes a display 520. The vehicle 510 includes various sensors, all of which can be examples of the image sensor(s) 205. The vehicle 510 includes a first camera 530A and a second camera 530B at the front, a third camera 530C and a fourth camera 530D at the rear, and a fifth camera 530E and a sixth camera 530F on the top. The vehicle 510 includes a first microphone 535A at the front, a second microphone 535B at the rear, and a third microphone 535C at the top. The vehicle 510 includes a first sensor 540A on one side (e.g., adjacent to one rear-view mirror) and a second sensor 540B on another side (e.g., adjacent to another rear-view mirror). The first sensor 540A and the second sensor 540B may include cameras, microphones, depth sensors (e.g., Radio Detection and Ranging (RADAR) sensors, Light Detection and Ranging (LIDAR) sensors, Sound Detection and Ranging (SODAR) sensors, Sound Navigation and Ranging (SONAR) sensors, time of flight (ToF) sensors, structured light sensors, stereoscopic cameras, etc.), or any other types of sensors(s) 205 described herein. In some examples, the vehicle 510 may include additional image sensor(s) 205 in addition to the sensors illustrated in FIG. 5. In some examples, the vehicle 510 may be missing some of the sensors that are illustrated in FIG. 5.

In some examples, the display 520 of the vehicle 510 displays one or more output images toward a user of the vehicle 510 (e.g., a driver and/or one or more passengers of the vehicle 510). In some examples, the output images can include the output data 280 and/or the pose 265 and/or the map 255. The output images can be based on the images (e.g., the image data 220) captured by the first camera 530A, the second camera 530B, the third camera 530C, the fourth camera 530D, the fifth camera 530E, the sixth camera 530F, the first sensor 540A, and/or the second sensor 540B, for example with the virtual content (e.g., the output data 280 and/or the pose 265 and/or the map 255) overlaid. In some examples, any of the first camera 530A, the second camera 530B, the third camera 530C, the fourth camera 530D, the fifth camera 530E, the sixth camera 530F, the first sensor 540A, and/or the second sensor 540B can be, or can include, depth sensors.

FIG. 6 is a conceptual diagram illustrating feature tracking in an image 600 with motion blur. The image is affected by motion blur due to motion of the camera, making the entire scene appear blurry. Features, such as the features 230, are illustrated overlaid over the image 600 as white triangles with black outlines. Certain features that are recognized from previous frames and that are tracked show a second, shaded triangle with a black outline, and a line in between the two triangles, indicating direction and distance of detected movement of the feature. Times are written near certain features, indicating how long those features have been traced in a sequence of images (e.g., a video). Because the image 600 is affected by motion blur, features in the image 600 appear to be moving in a variety of directions along a variety of distances, as a result of the uncertainty introduced by the motion blur. Thus, images that are strongly affected by motion blur, such as the image 600, can negatively affect feature tracking, making features that are extracted, detected, recognized, and/or tracked (e.g., using the feature tracker 225) unreliable for the purpose of feature tracking. This can in turn negatively impact environment mapping (e.g., using the mapping engine 250), pose estimation (e.g., using the pose engine 260), other SLAM functions (e.g., using the SLAM engine 245), other output generation functions (e.g., using the output processor 275), and/or other functions of an imaging system 200. An imaging system 200 that compensates for motion blur by giving less weight too features 230 extracted from such images (e.g., using the weights 240 generated using the motion blur estimator 235) can therefore be more accurate and reliable at feature tracking (e.g., using the feature tracker 225), environment mapping (e.g., using the mapping engine 250), pose estimation (e.g., using the pose engine 260), other SLAM functions (e.g., using the SLAM engine 245), other output generation functions (e.g., using the output processor 275), and/or other functions of an imaging system 200.

Furthermore, traditional auto-exposure control (AEC) systems control exposure based on image statistics of previously-captured images (e.g., average brightness, luminosity, and/or luma), and do not consider motion data. An imaging system 200 that uses motion data 270 from motion sensor(s) 215 to also impact determination of image capture setting(s) 210 such as exposure time (e.g., using the motion blur estimator 235, the AEC engine 805, and/or the AEC engine 1205) can also reduce the instance of images with motion blur (such as the image 600) in the first place, by reducing exposure time for images captured while the imaging system 200 is moving (e.g., more than a threshold speed or acceleration) (e.g., instead increasing gain for those images) and increasing exposure time back to normal image-statistics-based levels for images captured while the imaging system 200 is stationary (or moving less than a threshold speed).

FIG. 7 is a block diagram illustrating a process 700 for pose estimation that takes exposure time into account. The process 700 for imaging may be performed by an imaging system (e.g., a chipset, a processor or multiple processors such as an ISP, HP, or other processor, or other component). In some examples, the imaging system can include, for example, the image capture and processing system 100, the image capture device 105A, the image processing device 105B, the image processor 150, the ISP 154, the host processor 152, the imaging system 200, the image sensor(s) 205, the motion sensor(s) 215, the feature tracker 225, the motion blur estimator 235, the SLAM engine 245, the mapping engine 250, the pose engine 260, the output processor 275, and/or the trained ML model(s) 290, the trained ML model(s) 290, the feedback engine 295, the HMD 310, the mobile handset 410, the vehicle 510, the imaging system(s) that perform any of processes described herein (e.g., the process 800, the process 900, the process 1000, the process 1200, the process 1400), the camera 1105, the neural network 1300, the computing system 1500, the processor 1510, a system, and apparatus, a device, a non-transitory computer readable medium having stored thereon a program to be performed using a processor, or a combination thereof.

The imaging system receives an image 705 (e.g., image data 220) and uses the image 705 to perform feature tracking 715 (e.g., using the feature tracker 225). The imaging system uses the feature tracking 715 for pose estimation 720 to estimate a pose 725 of the imaging system, for instance using triangulation to estimate the pose 725. The imaging system can also receive the exposure time 710 setting used to capture the image 705, which the imaging system can use to determine a confidence 730 associated with the pose 725 estimated via pose estimation 720. For instance, a higher exposure time can result in a lower confidence 730 due to the increased possibility of motion blur, while a lower exposure time can result in a higher confidence 730 due to the decreased possibility of motion blur.

The imaging system also receives accelerometer data 735 and/or gyro data 740 as motion data 270 from motion sensor(s) 215. The imaging system uses the accelerometer data 735 and/or the gyro data 740 for state propagation 745 to determine an IMU propagated state 750. The imaging system includes a pose estimator 755 that receives the pose 725, the confidence 730, and the IMU propagated state 750 to determine an output pose 760. The pose estimator 755 may use a Kalman filter, an extended Kalman filter, another pose estimation function, or a combination thereof. The pose estimation 720 and/or the pose estimator 755 may be examples of portion(s) of the pose engine 260. The pose 725 and/or the output pose 760 may be examples of the pose 265.

FIG. 8 is a block diagram illustrating a process 800 for automatic exposure control that takes motion data into account. The process 800 for imaging may be performed by an imaging system (e.g., a chipset, a processor or multiple processors such as an ISP, HP, or other processor, or other component). In some examples, the imaging system can include, for example, the image capture and processing system 100, the image capture device 105A, the image processing device 105B, the image processor 150, the ISP 154, the host processor 152, the imaging system 200, the image sensor(s) 205, the motion sensor(s) 215, the feature tracker 225, the motion blur estimator 235, the SLAM engine 245, the mapping engine 250, the pose engine 260, the output processor 275, and/or the trained ML model(s) 290, the trained ML model(s) 290, the feedback engine 295, the HMD 310, the mobile handset 410, the vehicle 510, the imaging system(s) that perform any of processes described herein (e.g., the process 700, the process 900, the process 1000, the process 1200, the process 1400), the camera 1105, the neural network 1300, the computing system 1500, the processor 1510, a system, and apparatus, a device, a non-transitory computer readable medium having stored thereon a program to be performed using a processor, or a combination thereof.

The imaging system includes an AEC engine 805 with an exposure/gain table 810 that identifies exposure time settings and gain settings to be used by a camera 830. The AEC engine 805 can output image capture settings 820 (e.g., including exposure time and/or gain) (e.g., image capture setting(s) 210) to the camera 830 (e.g., image sensor(s) 205). There may be a delay 825 (e.g., of N frames when the camera 830 is capturing video) before the image capture settings 820 are applied by the camera 830. After the delay 825, the camera 830 captures a raw image 835 with the image capture settings 820 applied. The AEC engine 805 can determine an adjustment 815 (e.g., increase or decrease) to a maximum exposure time based on image statistics of the raw image 835, to generate a new maximum exposure time 840. The adjustment 815 can be made to match an image luma of the raw image 835 (e.g., an average luma for the raw image 835) to a target luma. The new maximum exposure time 840, along with motion-aware AEC settings 845 based on motion data 270 received from motion sensor(s) 215, are used by the imaging system to determine an update 850 to the exposure/gain table 810. For instance, the motion-aware AEC settings 845 can adjust the new maximum exposure time 840 down if the imaging system is determined to be in motion (e.g., translational and/or rotational speed and/or acceleration exceeding a threshold), or can leave the new maximum exposure time 840 where it is if the imaging system is determined to be stationary (e.g., translational and/or rotational speed and/or acceleration below a threshold). The updated exposure/gain table 810 can then be used to determine further image capture settings 820 to be used by the camera 830 to capture further raw images 835, and to forth. The AEC engine 805 and/or other image processing subsystems of the imaging system can process each raw image 835 to produce an image 855, which can be used by a feature tracker 860 (e.g., feature tracker 225, feature tracking 715).

FIG. 9 is a flow diagram illustrating a process 900 for pose estimation that takes estimated motion blur into account. The process 900 for imaging may be performed by an imaging system (e.g., a chipset, a processor or multiple processors such as an ISP, HP, or other processor, or other component). In some examples, the imaging system can include, for example, the image capture and processing system 100, the image capture device 105A, the image processing device 105B, the image processor 150, the ISP 154, the host processor 152, the imaging system 200, the image sensor(s) 205, the motion sensor(s) 215, the feature tracker 225, the motion blur estimator 235, the SLAM engine 245, the mapping engine 250, the pose engine 260, the output processor 275, and/or the trained ML model(s) 290, the trained ML model(s) 290, the feedback engine 295, the HMD 310, the mobile handset 410, the vehicle 510, the imaging system(s) that perform any of processes described herein (e.g., the process 700, the process 800, the process 1000, the process 1200, the process 1400), the camera 1105, the neural network 1300, the computing system 1500, the processor 1510, a system, and apparatus, a device, a non-transitory computer readable medium having stored thereon a program to be performed using a processor, or a combination thereof.

At operation 905, the imaging system (or component thereof) is configured to, and can, determine an initial pose, 3D points and their correspondences (observations) in an image. At operation 910, the imaging system (or component thereof) is configured to, and can, determine exposure time & motion information from 6DOF (e.g., from an AEC engine, motion sensor(s) 215, and/or optical flow).

At operation 915, the imaging system (or component thereof) is configured to, and can, estimate motion blur of feature points based on exposure time, depth & motion. The imaging system can recompute measurement variance of all tracked points with motion blur. At operation 920, the imaging system (or component thereof) is configured to, and can, use an optimization framework to generate a pose estimate 925 based on the data from operations 905 and 915. The pose estimate 925 can include a pose measurement and/or a covariance to the Kalman filter.

FIG. 10 is a flow diagram illustrating a process 1000 for pose estimation that takes estimated motion blur into account. The process 1000 for imaging may be performed by an imaging system (e.g., a chipset, a processor or multiple processors such as an ISP, HP, or other processor, or other component). In some examples, the imaging system can include, for example, the image capture and processing system 100, the image capture device 105A, the image processing device 105B, the image processor 150, the ISP 154, the host processor 152, the imaging system 200, the image sensor(s) 205, the motion sensor(s) 215, the feature tracker 225, the motion blur estimator 235, the SLAM engine 245, the mapping engine 250, the pose engine 260, the output processor 275, and/or the trained ML model(s) 290, the trained ML model(s) 290, the feedback engine 295, the HMD 310, the mobile handset 410, the vehicle 510, the imaging system(s) that perform any of processes described herein (e.g., the process 700, the process 800, the process 900, the process 1200, the process 1400), the camera 1105, the neural network 1300, the computing system 1500, the processor 1510, a system, and apparatus, a device, a non-transitory computer readable medium having stored thereon a program to be performed using a processor, or a combination thereof.

At operation 1005, the imaging system (or component thereof) is configured to, and can, determine an initial pose, 3D points and their correspondences (observations) in an image. At operation 1010, the imaging system (or component thereof) is configured to, and can, compute reprojection errors in reprojection (e.g., see FIG. 11). At operation 1015, the imaging system (or component thereof) is configured to, and can, compute weights (e.g., weights 240) based on feature tracking statistics, such as reprojection and feature tracking quality.

At operation 1020, the imaging system (or component thereof) is configured to, and can, determine exposure time & motion information from 6DOF (e.g., from an AEC engine, motion sensor(s) 215, and/or optical flow) and/or from an Extended Kalman Filter (EKF).

At operation 1025, the imaging system (or component thereof) is configured to, and can, estimate motion blur of feature points based on exposure time, depth & motion. The imaging system can use the weight function (provided below in Equation 1) to recompute weights to the computed weights based on motion blur:

$$weightFn ( δ , r ) = \{ \begin{matrix}a & r < δ \\ \frac{b}{r} & otherwise\end{matrix} \qquad Equation 1$$

Within Equation 1, a and b are constants. r represents a magnitude of motion blur. 8 represents a threshold magnitude of motion blur, for instance 1 pixel or less. In some examples, the threshold is more than one pixel (e.g., 2 pixels, 3 pixels, etc.). The weight function (Equation 1) is used to represent additional error variance due of motion blur.

At operation 1030, the imaging system (or component thereof) is configured to, and can, estimate a pose (e.g., using the recomputed weights of operation 1025) minimizing weighted least squares of reprojection errors (e.g., the reprojection errors of operation 1010). The imaging system can cycle back to operation 1010, checking each time at decision point 1035 whether a maximum number of iterations has been reached. If not, the imaging system cycles back to operation 1010. If so, the imaging system generates the pose estimate 1040 based on the pose estimation of operation 1030. The pose estimate 1040 can include a pose measurement and/or a covariance to the Kalman filter.

FIG. 11 is a conceptual diagram 1100 illustrating image reprojection. A dot is illustrated representing the position of a camera 1105. Dark markers are illustrated along an image plane 1110, representing observations 1115 of features along the image plane 1110. Additional markers are illustrated in the 3D space beyond the image plane 1110, representing 3D point estimates 1120 corresponding to each of the features observed in the observations 1115. The 3D point estimates 1120 include nearby points 1125, illustrated as white markers with black outlines, and farther points 1130, illustrated as black markers with dotted outlines. As discussed with respect to the weights 240, in some examples, higher weights can be assigned features representing the farther points 1130 than for features representing the nearby points 1125.

A pose of the camera 1105 is estimated by tracking feature points in the image represented by the image plane 1110. A motion blur image formation model can be used according to Equations 2-5 below:

$$B ( x ) = λ {\int }_{0}^{τ} {I}_{t} ( x ) dt \qquad Equation 2$$

$${x}_{i}^{t} = π ( {X}_{i} ) \qquad Equation 3$$

$${x}_{i}^{t + τ} = π ( T * {X}_{i} ) \qquad Equation 4$$

$$Δ x = ‖ {x}_{i}^{t + dT} - {x}_{i}^{t} ‖ \qquad Equation 5$$

Within Equations 2-5, Δx as computed using Equation 5 represents the motion blur of a feature point i. xᵢ represents a feature point i in the camera. T=[R t] represents a delta pose of the camera during the exposure window. R=exp [ω*dT]ₓ represents the delta rotation of the camera per t=v×dT+0.5a×dT². dT represents the exposure time. B(x)∈R^{W×H} is the captured image (e.g., the motion-blurred image). Iₜ(x) is a virtual sharp image captured at time t. T is the exposure time. The estimated motion blur is used (e.g., by the motion blur estimator 235) in pose estimation (e.g., by pose engine 260) to compute reliable pose from tracked feature, and/or in some cases in feature tracking (e.g., by feature tracker 225), environment mapping (e.g., by mapping engine 250), and/or other SLAM functions (e.g., by SLAM engine 245).

If motion and scene information is available from 6DOF, the imagng system computes motion blur of few control points in the image at different exposure levels. The imaging system selects maximum exposure time for which motion blur of these control points is less than 1-2 pixels. The imaging system computes motion blur as pixel movement during the exposure window in the image. Where Depth information is available, equation 6 is used along with Equations 2-5:

$${x}_{i}^{τ} = π ( T * {π}^{- 1} ( {x}_{i} , {d}_{i} ) ) \qquad Equation 6$$

In Equation 6, xᵢ represents the control point location at t. xᵢ^{τ} represents the control point location at t+dT. π represents the camera function. T=[R t] represents the delta pose of the camera during the exposure window. R=exp [ω*dT]ₓ represents the delta rotation of the camera. t=v×dT+0.5a×dT². dT represents the exposure time to be estimated. Δx=∥xᵢ^{τ}−xᵢ∥ represents the amount of motion blur.

In some examples, angular velocity is provided from an IMU and/or gyroscope. In some examples (e.g., extended reality (XR) applications), many fast motions are rotational motions. In XR applications, assuming pure rotation is a reasonable approximation. Depth information is not required in pure rotations. Equations 2-6 can be used, with the modification that T=[R] and dᵢ=1.0 m.

In some examples, motion is provided via optical flow. Optical flow gives apparent motion of individual pixels on the image plane 1110. The imaging system can compute a median of the image point displacement from the optical flow information across frames. A maximum exposure time can be computed as in Equation 7 below:

$$d T = a / ( b * FPS ) \qquad Equation 7$$

In Equation 7, dT represents a maximum exposure time. a represents a maximum allowable magnitude of motion blur. b represents a median of the image point displacement from optical flow data. The FPS represents the rate of image capture in frames per second, measured in hertz (Hz).

FIG. 12 is a block diagram illustrating a process 1200 for automatic exposure control that takes angular velocity, motion information, scene depth, and/or optical flow into account. The process 1200 for imaging may be performed by an imaging system (e.g., a chipset, a processor or multiple processors such as an ISP, HP, or other processor, or other component). In some examples, the imaging system can include, for example, the image capture and processing system 100, the image capture device 105A, the image processing device 105B, the image processor 150, the ISP 154, the host processor 152, the imaging system 200, the image sensor(s) 205, the motion sensor(s) 215, the feature tracker 225, the motion blur estimator 235, the SLAM engine 245, the mapping engine 250, the pose engine 260, the output processor 275, and/or the trained ML model(s) 290, the trained ML model(s) 290, the feedback engine 295, the HMD 310, the mobile handset 410, the vehicle 510, the imaging system(s) that perform any of processes described herein (e.g., the process 700, the process 800, the process 900, the process 1000, and/or the process 1400), the camera 1105, the neural network 1300, the computing system 1500, the processor 1510, a system, and apparatus, a device, a non-transitory computer readable medium having stored thereon a program to be performed using a processor, or a combination thereof.

The imaging system includes an AEC engine 1205 (e.g., AEC engine 805) with an exposure/gain table 1210 (e.g., exposure/gain table 810) that identifies exposure time settings and gain settings to be used by a camera 1230 (e.g., camera 830, image sensor(s) 205). The AEC engine 1205 can output image capture settings 1220 (e.g., including exposure time and/or gain) (e.g., image capture setting(s) 820, image capture setting(s) 210) to the camera 1230. There may be a delay 1225 (e.g., of N frames when the camera 1230 is capturing video) (e.g., delay 825) before the image capture settings 1220 are applied by the camera 1230. After the delay 1225, the camera 1230 captures a raw image 1235 (e.g., raw image 835, image data 220) with the image capture settings 1220 applied.

The imaging system can receive motion data 270 from motion sensor(s) 215 and/or from optical flow analysis of previous image(s), for instance including include angular velocity 1242 from an IMU and/or gyroscope, motion information 1244 and/or scene depth information 1246 from six degrees of freedom (6DoF) sensor(s), optical flow data 1248 from previous image(s) (e.g., previous image data captured by the camera 1230 before the raw image 1235). The imaging system can use this data, along with information about the geometry of the camera 1230 and/or adjustments to the exposure determined by the AEC engine 1205 to match image luma of the raw image 1235 to a target luma (e.g., adjustment 815), to determine a maximum exposure time 1240, which the imaging system can use to generate an update 1250 to the exposure/gain table 1210. For instance, the motion-aware AEC settings 1245 can reduce the maximum exposure time 1240 if the imaging system is determined to be in motion (e.g., translational and/or rotational speed and/or acceleration exceeding a threshold), or can increase the maximum exposure time 1240 or leave the maximum exposure time 1240 where the AEC engine 1205 suggests it to be (e.g., based on the adjustment 815) if the imaging system is determined to be stationary (e.g., translational and/or rotational speed and/or acceleration below a threshold). The updated exposure/gain table 1210 can then be used to determine further image capture settings 1220 to be used by the camera 1230 to capture further raw images 1235, and to forth. The AEC engine 1205 and/or other image processing subsystems of the imaging system can process each raw image 1235 to produce an image 1255 (e.g., image 855, image data 220), which can be used by a feature tracker 1260 (e.g., feature tracker 225, feature tracking 715).

At extremely low light (e.g., less than 5 lux) or low light (e.g., 15-30 lux), the imaging system can allow the max exposure time to go higher during slower motion helps in capturing better images with sufficient contrast required for 6DOF tracking. At slower motions, the imaging system can allow max exposure to go up to 8 ms to help in capturing images with less noise. Example low exposure settings (e.g., during motion and extreme low light) can include exposure time=2 ms; gain=Max gain. Using a motion-aware AEC, the exposure settings (e.g., during motion even at low light) can include exposure time=8 ms; gain=Max gain.

FIG. 13 is a block diagram illustrating an example of a neural network (NN) 1300 that can be used for media processing operations. The neural network 1300 can include any type of deep network, such as a convolutional neural network (CNN), an autoencoder, a deep belief net (DBN), a Recurrent Neural Network (RNN), a Generative Adversarial Networks (GAN), and/or other type of neural network. The neural network 1300 may be an example of one of the trained ML model(s) 290. The neural network 1300 may used by the feature tracker 225, the motion blur estimator 235, the SLAM engine 245, the mapping engine 250, the pose engine 260, the output processor 275, the feedback engine 295, or a combination thereof.

An input layer 1310 of the neural network 1300 includes input data. The input data of the input layer 1310 can include data representing the pixels of one or more input image frames. In some examples, the input data of the input layer 1310 includes data representing the pixels of image data (e.g., the image data 220, an image captured by one of the cameras 330A-330D, an image captured by one of the cameras 430A-430D, an image captured by one of the cameras 530A-530F, the image 600, the image 705, the raw image 835, the image 855, the image plane 1110, the raw image 1235, the image 1255, the image data of operation 1405, image(s) captured using the input device 1545, or a combination thereof). In some examples, the input data of the input layer 1310 includes motion data 270 captured by motion sensor(s) 215. In some examples, the input data of the input layer 1310 includes depth data captured by depth sensor(s). In some examples, the input data of the input layer 1310 includes processed data that is to be processed further, such as the features 230, the weights 240, the map 255, the pose 265, the output data 280, or a combination thereof.

The images can include image data from an image sensor including raw pixel data (including a single color per pixel based, for example, on a Bayer filter) or processed pixel values (e.g., RGB pixels of an RGB image). The neural network 1300 includes multiple hidden layers 1312, 1312B, through 1312N. The hidden layers 1312, 1312B, through 1312N include “N” number of hidden layers, where “N” is an integer greater than or equal to one. The number of hidden layers can be made to include as many layers as needed for the given application. The neural network 1300 further includes an output layer 1314 that provides an output resulting from the processing performed by the hidden layers 1312, 1312B, through 1312N.

In some examples, the output layer 1314 can provide output data, such as the features 230, the weights 240, the map 255, the pose 265, the output data 280, or intermediate data used (e.g., by the feature tracker 225, the motion blur estimator 235, the SLAM engine 245, the mapping engine 250, the pose engine 260, the output processor 275, the feedback engine 295, or a combination thereof) for generating any of these.

The neural network 1300 is a multi-layer neural network of interconnected filters. Each filter can be trained to learn a feature representative of the input data. Information associated with the filters is shared among the different layers and each layer retains information as information is processed. In some cases, the neural network 1300 can include a feed-forward network, in which case there are no feedback connections where outputs of the network are fed back into itself. In some cases, the network 1300 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 1310 can activate a set of nodes in the first hidden layer 1312A. For example, as shown, each of the input nodes of the input layer 1310 can be connected to each of the nodes of the first hidden layer 1312A. The nodes of a hidden layer can transform the information of each input node by applying activation functions (e.g., filters) to this information. The information derived from the transformation can then be passed to and can activate the nodes of the next hidden layer 1312B, which can perform their own designated functions. Example functions include convolutional functions, downscaling, upscaling, data transformation, and/or any other suitable functions. The output of the hidden layer 1312B can then activate nodes of the next hidden layer, and so on. The output of the last hidden layer 1312N can activate one or more nodes of the output layer 1314, which provides a processed output image. In some cases, while nodes (e.g., node 1316) in the neural network 1300 are shown as having multiple output lines, a node has a single output and all lines shown as being output from a node represent the same output value.

In some cases, each node or interconnection between nodes can have a weight that is a set of parameters derived from the training of the neural network 1300. For example, an interconnection between nodes can represent a piece of information learned about the interconnected nodes. The interconnection can have a tunable numeric weight that can be tuned (e.g., based on a training dataset), allowing the neural network 1300 to be adaptive to inputs and able to learn as more and more data is processed.

The neural network 1300 is pre-trained to process the features from the data in the input layer 1310 using the different hidden layers 1312, 1312B, through 1312N in order to provide the output through the output layer 1314.

FIG. 14 is a flow diagram illustrating a process 1400 for imaging. The process 1400 for imaging may be performed by an imaging system (e.g., a chipset, a processor or multiple processors such as an ISP, HP, or other processor, or other component). In some examples, the imaging system can include, for example, the image capture and processing system 100, the image capture device 105A, the image processing device 105B, the image processor 150, the ISP 154, the host processor 152, the imaging system 200, the image sensor(s) 205, the motion sensor(s) 215, the feature tracker 225, the motion blur estimator 235, the SLAM engine 245, the mapping engine 250, the pose engine 260, the output processor 275, and/or the trained ML model(s) 290, the trained ML model(s) 290, the feedback engine 295, the HMD 310, the mobile handset 410, the vehicle 510, the imaging system(s) that perform any of processes described herein (e.g., the process 700, the process 800, the process 900, the process 1000, and/or the process 1200), the camera 1105, the neural network 1300, the computing system 1500, the processor 1510, a system, and apparatus, a device, a non-transitory computer readable medium having stored thereon a program to be performed using a processor, or a combination thereof. In some examples, the imaging system includes a display. In some examples, the imaging system includes a transceiver and/or other communication interface(s).

At operation 1405, the imaging system (or component thereof) is configured to, and can, receive an image of an environment captured using at least one image sensor according to an image capture setting.

Illustrative examples of the image sensor includes the image sensor 130, the image sensor(s) 205, the first camera 330A, the second camera 330B, the third camera 330C, the fourth camera 330D, the first camera 430A, the second camera 430B, the third camera 430C, the fourth camera 430D, the first camera 530A, the second camera 530B, the third camera 530C, the fourth camera 530D, the fifth camera 530E, the sixth camera 530F, the first sensor 540A, the second sensor 540B, the sensors 625, an image sensor used to capture an image used as input data for the input layer 1310 of the NN 1300, the input device 1545, another image sensor described herein, another sensor described herein, or a combination thereof. Examples of the depth sensor includes the image sensor(s) 205, the first sensor 540A, the second sensor 540B, the sensors 625, a depth sensor used to capture depth data used as input data for the input layer 1310 of the NN 1300, the input device 1545, another depth sensor described herein, another sensor described herein, or a combination thereof. Examples of the image data include the image data 220 and/or image data captured by any of the previously-listed image sensors.

In some aspects, the image capture setting includes an exposure time. Examples of the image capture setting include the image capture setting(s) 210, the exposure time 710, the image capture setting(s) 820, the exposure time of operations 910 and/or 1020, and the image capture setting(s) 1220.

At operation 1410, the imaging system (or component thereof) is configured to, and can, receive motion data captured using a motion sensor. Examples of the motion sensor include the motion sensor(s) 215. Examples of the motion data include the motion data 270, the accelerometer data 735, the gyro data 740, the motion information of operations 910 and/or 1020, the angular velocity 1242, and/or the motion information 1244.

At operation 1415, the imaging system (or component thereof) is configured to, and can, determine a weight (e.g., weights 240) associated with at least one of a plurality of features (e.g., features 230) of the environment in the image based on an estimated motion blur level (e.g., determined using the motion blur estimator 235) for the at least one of the features of the environment in the image. The estimated motion blur level is based on the motion data and the image capture setting.

In some aspects, the imaging system (or component thereof) is configured to, and can, determine the estimated motion blur level for the at least one of the features of the environment in the image (e.g., using the motion blur estimator 235).

In some aspects, the estimated motion blur level for the at least one of the features of the environment in the image is based on a distance from the at least one image sensor to the at least one of the features of the environment, wherein the weight associated with the at least one of the features of the environment in the image is based on the distance from the at least one image sensor to the at least one of the features of the environment. For instance, the distance can be closer than a threshold (e.g., the nearby points 1125) or farther than a threshold (e.g., the farther points 1130).

In some aspects, the imaging system (or component thereof) is configured to, and can, determine a ratio of a constant divided by the estimated motion blur level for the image to determine the weight associated with the image based on the estimated motion blur level for the at least one of the features of the environment in the image (e.g., as in the ratio b/r in Equation 1).

In some aspects, the estimated motion blur level is an estimated magnitude of motion blur.

At operation 1420, the imaging system (or component thereof) is configured to, and can, track the features of the environment across a plurality of images (e.g., of the image data 220) according to respective weights (e.g., weights 240) for the features (e.g., features 230) of the environment across the plurality of images. The plurality of images includes the image, and the respective weights include the weight.

In some aspects, the imaging system (or component thereof) is configured to, and can, determine a pose of the imaging system (e.g., pose 265 as determined by the pose engine 260) in the environment based on the features tracked in the plurality of images and according to the respective weights for the features of the environment in the plurality of images. The imaging system includes the at least one image sensor and the motion sensor. In some aspects, the imaging system (or component thereof) is configured to, and can, minimize weighed least squares of reprojection errors according to the respective weights of the features of the environment in the plurality of images to determine the pose of the apparatus in the environment (e.g., as in operation 1030). In some aspects, the imaging system (or component thereof) is configured to, and can, output an indication of the pose of the imaging system (e.g., outputting the pose 265 and/or the output data 280 via the output device(s) 285).

In some aspects, the imaging system (or component thereof) is configured to, and can, map the environment based on the features of the environment tracked in the plurality of images and according to the respective weights of the features of the environment for the plurality of images to generate a map of the environment (e.g., the map 255 generated using the mapping engine 250). In some aspects, the imaging system (or component thereof) is configured to, and can, determining a location of the imaging system (e.g., the pose 265) within the map of the environment based on the features of the environment tracked in the plurality of images and according to the respective weights of the features of the environment for the plurality of images, wherein the imaging system includes the at least one image sensor and the motion sensor. In some aspects, the imaging system (or component thereof) is configured to, and can, output at least a portion of the map of the environment (e.g., outputting the map 255 and/or the output data 280 via the output device(s) 285).

In some aspects, the respective weights for the features of the environment across the plurality of images correspond to respective error variance values for the plurality of images. In some aspects, the imaging system (or component thereof) is configured to, and can, track the features of the environment across the plurality of images according to the respective error variance values for the plurality of images to track the features of the environment across the plurality of images according to the respective weights for the features of the environment across the plurality of images (e.g., as in Equation 1).

In some aspects, the imaging system (or component thereof) is configured to, and can, determine that the estimated motion blur level is less than a predetermined threshold (e.g., threshold δ in Equation 1); and set the weight associated with the at least one of the features of the environment in the image to a predetermined value (e.g., constant a in Equation 1) in response to determining that the estimated motion blur level is less than the predetermined threshold to determine the weight associated with the at least one of the features of the environment in the image based on the estimated motion blur level for the at least one of the features of the environment in the image. In some aspects, the predetermined threshold represents a magnitude of motion blur that is no larger than a pixel.

In some examples, the processes described herein (e.g., the process of FIG. 1, the process of FIG. 2, the process 700 of FIG. 7, the process 800 of FIG. 8, the process 900 of FIG. 9, the process 1000 of FIG. 10, the process of FIG. 11, the process 1200 of FIG. 12, the process of FIG. 13, the process 1400 of FIG. 14, and/or other processes described herein) may be performed by a computing device or apparatus. In some examples, the processes described herein can be performed by the image capture and processing system 100, the image capture device 105A, the image processing device 105B, the image processor 150, the ISP 154, the host processor 152, the imaging system 200, the image sensor(s) 205, the motion sensor(s) 215, the feature tracker 225, the motion blur estimator 235, the SLAM engine 245, the mapping engine 250, the pose engine 260, the output processor 275, and/or the trained ML model(s) 290, the trained ML model(s) 290, the feedback engine 295, the HMD 310, the mobile handset 410, the vehicle 510, the imaging system(s) that perform any of processes described herein (e.g., the process 700, the process 800, the process 900, the process 1000, the process 1200, and/or the process 1400), the camera 1105, the neural network 1300, the computing system 1500, the processor 1510, or a combination thereof.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, a vehicle or computing device of a vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 15 is a diagram illustrating an example of a system for implementing certain aspects of the present technology. In particular, FIG. 15 illustrates an example of computing system 1500, which can be for example any computing device making up internal computing system, a remote computing system, a camera, or any component thereof in which the components of the system are in communication with each other using connection 1505. Connection 1505 can be a physical connection using a bus, or a direct connection into processor 1510, such as in a chipset architecture. Connection 1505 can also be a virtual connection, networked connection, or logical connection.

In some aspects, computing system 1500 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1500 includes at least one processing unit (CPU or processor) 1510 and connection 1505 that couples various system components including system memory 1515, such as read-only memory (ROM) 1520 and random access memory (RAM) 1525 to processor 1510. Computing system 1500 can include a cache 1512 of high-speed memory connected directly with, in close proximity to, or integrated as part of processor 1510.

Processor 1510 can include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which can represent any number of input mechanisms, such as a microphone for speech, a touch-sensitive screen for gesture or graphical input, keyboard, mouse, motion input, speech, etc. Computing system 1500 can also include output device 1535, which can be one or more of a number of output mechanisms. In some instances, multimodal systems can enable a user to provide multiple types of input/output to communicate with computing system 1500. Computing system 1500 can include communications interface 1540, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1502.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1530 can include software services, servers, services, etc., that when the code that defines such software is executed by the processor 1510, it causes the system to perform a function. In some aspects, a hardware service that performs a particular function can include the software component stored in a computer-readable medium in connection with the necessary hardware components, such as processor 1510, connection 1505, output device 1535, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for environment mapping, the apparatus comprising: a memory; and at least one processor (e.g., implemented in circuitry) coupled to the memory and configured to: receive an image of an environment captured using at least one image sensor according to an image capture setting; receive motion data captured using a motion sensor; determine a weight associated with at least one of a plurality of features of the environment in the image based on an estimated motion blur level for the at least one of the features of the environment in the image, wherein the estimated motion blur level is based on the motion data and the image capture setting; and track the features of the environment across a plurality of images according to respective weights for the features of the environment across the plurality of images, wherein the plurality of images includes the image, and wherein the respective weights include the weight.

Aspect 2. The apparatus of Aspect 1, wherein the at least one processor is configured to: determine a pose of the apparatus in the environment based on the features tracked in the plurality of images and according to the respective weights for the features of the environment in the plurality of images.

Aspect 3. The apparatus of any of Aspects 1 to 2, wherein the at least one processor is configured to: minimize weighed least squares of reprojection errors according to the respective weights of the features of the environment in the plurality of images to determine the pose of the apparatus in the environment.

Aspect 4. The apparatus of any of Aspects 1 to 3, wherein the at least one processor is configured to: output an indication of the pose of the apparatus.

Aspect 5. The apparatus of any of Aspects 1 to 4, wherein the at least one processor is configured to: map the environment based on the features of the environment tracked in the plurality of images and according to the respective weights of the features of the environment for the plurality of images to generate a map of the environment.

Aspect 6. The apparatus of any of Aspects 1 to 5, wherein the at least one processor is configured to: determine a location of the apparatus within the map of the environment based on the features of the environment tracked in the plurality of images and according to the respective weights of the features of the environment for the plurality of images.

Aspect 7. The apparatus of any of Aspects 1 to 6, wherein the at least one processor is configured to: output at least a portion of the map of the environment.

Aspect 8. The apparatus of any of Aspects 1 to 7, wherein the respective weights for the features of the environment across the plurality of images correspond to respective error variance values for the plurality of images, wherein the at least one processor is configured to track the features of the environment across the plurality of images according to the respective error variance values for the plurality of images to track the features of the environment across the plurality of images according to the respective weights for the features of the environment across the plurality of images.

Aspect 9. The apparatus of any of Aspects 1 to 8, wherein the at least one processor is configured to: determine the estimated motion blur level for the at least one of the features of the environment in the image.

Aspect 10. The apparatus of any of Aspects 1 to 9, wherein the estimated motion blur level for the at least one of the features of the environment in the image is based on a distance from the at least one image sensor to the at least one of the features of the environment, wherein the weight associated with the at least one of the features of the environment in the image is based on the distance from the at least one image sensor to the at least one of the features of the environment.

Aspect 11. The apparatus of any of Aspects 1 to 10, wherein the at least one processor is configured to: determine a ratio of a constant divided by the estimated motion blur level for the image to determine the weight associated with the image based on the estimated motion blur level for the at least one of the features of the environment in the image.

Aspect 12. The apparatus of any of Aspects 1 to 11, wherein the at least one processor is configured to: determine that the estimated motion blur level is less than a predetermined threshold; and set the weight associated with the at least one of the features of the environment in the image to a predetermined value in response to determining that the estimated motion blur level is less than the predetermined threshold to determine the weight associated with the at least one of the features of the environment in the image based on the estimated motion blur level for the at least one of the features of the environment in the image.

Aspect 13. The apparatus of any of Aspects 1 to 12, wherein the predetermined threshold represents a magnitude of motion blur that is no larger than a pixel.

Aspect 14. The apparatus of any of Aspects 1 to 13, wherein the estimated motion blur level is an estimated magnitude of motion blur.

Aspect 15. The apparatus of any of Aspects 1 to 14, wherein the image capture setting includes an exposure time.

Aspect 16. The apparatus of any of Aspects 1 to 15, wherein the apparatus is at least one of a mobile device, a wireless communication device, or an extended reality device.

Aspect 17. A method for imaging, the method comprising: receiving an image of an environment captured using at least one image sensor according to an image capture setting; receiving motion data captured using a motion sensor; determining a weight associated with at least one of a plurality of features of the environment in the image based on an estimated motion blur level for the at least one of the features of the environment in the image, wherein the estimated motion blur level is based on the motion data and the image capture setting; and tracking the features of the environment across a plurality of images according to respective weights for the features of the environment across the plurality of images, wherein the plurality of images includes the image, and wherein the respective weights include the weight.

Aspect 18. The method of Aspect 17, further comprising: determining a pose of a device in the environment based on the features tracked in the plurality of images and according to the respective weights for the features of the environment in the plurality of images, wherein the device includes the at least one image sensor and the motion sensor.

Aspect 19. The method of any of Aspects 17 to 18, further comprising: minimizing weighed least squares of reprojection errors according to the respective weights of the features of the environment in the plurality of images to determine the pose of the device in the environment.

Aspect 20. The method of any of Aspects 17 to 19, further comprising: outputting an indication of the pose of the device.

Aspect 21. The method of any of Aspects 17 to 20, further comprising: mapping the environment based on the features of the environment tracked in the plurality of images and according to the respective weights of the features of the environment for the plurality of images to generate a map of the environment.

Aspect 22. The method of any of Aspects 17 to 21, further comprising: determining a location of a device within the map of the environment based on the features of the environment tracked in the plurality of images and according to the respective weights of the features of the environment for the plurality of images, wherein the device includes the at least one image sensor and the motion sensor.

Aspect 23. The method of any of Aspects 17 to 22, further comprising: outputting at least a portion of the map of the environment.

Aspect 24. The method of any of Aspects 17 to 23, wherein the respective weights for the features of the environment across the plurality of images correspond to respective error variance values for the plurality of images, further comprising: tracking the features of the environment across the plurality of images according to the respective error variance values for the plurality of images to track the features of the environment across the plurality of images according to the respective weights for the features of the environment across the plurality of images.

Aspect 25. The method of any of Aspects 17 to 24, further comprising: determining the estimated motion blur level for the at least one of the features of the environment in the image.

Aspect 26. The method of any of Aspects 17 to 25, wherein the estimated motion blur level for the at least one of the features of the environment in the image is based on a distance from the at least one image sensor to the at least one of the features of the environment, wherein the weight associated with the at least one of the features of the environment in the image is based on the distance from the at least one image sensor to the at least one of the features of the environment.

Aspect 27. The method of any of Aspects 17 to 26, further comprising: determining a ratio of a constant divided by the estimated motion blur level for the image to determine the weight associated with the image based on the estimated motion blur level for the at least one of the features of the environment in the image.

Aspect 28. The method of any of Aspects 17 to 27, further comprising: determining that the estimated motion blur level is less than a predetermined threshold; and setting the weight associated with the at least one of the features of the environment in the image to a predetermined value in response to determining that the estimated motion blur level is less than the predetermined threshold to determine the weight associated with the at least one of the features of the environment in the image based on the estimated motion blur level for the at least one of the features of the environment in the image.

Aspect 29. The method of any of Aspects 17 to 28, wherein the predetermined threshold represents a magnitude of motion blur that is no larger than a pixel.

Aspect 30. The method of any of Aspects 17 to 29, wherein the estimated motion blur level is an estimated magnitude of motion blur.

Aspect 31. The method of any of Aspects 17 to 30, wherein the image capture setting includes an exposure time.

Aspect 32. The method of any of Aspects 17 to 31, wherein the method is configured to be performed using an apparatus that includes at least one of a mobile device, a wireless communication device, or an extended reality device.

Aspect 33. A non-transitory computer-readable medium having stored thereon instructions that, when executed by one or more processors, cause the one or more processors to perform operations according to any of Aspects 1 to 32.

Aspect 34. An apparatus for imaging, the apparatus comprising one or more means for performing operations according to any of Aspects 1 to 32.

What is claimed is:

1. An apparatus for imaging, the apparatus comprising:
at least one memory; and
at least one processor coupled to the at least one memory and configured to:
receive an image of an environment captured using at least one image sensor according to an image capture setting;
receive motion data captured using a motion sensor;
determine a weight associated with at least one of a plurality of features of the environment in the image based on an estimated motion blur level for the at least one of the features of the environment in the image, wherein the estimated motion blur level is based on the motion data and the image capture setting; and
track the features of the environment across a plurality of images according to respective weights for the features of the environment across the plurality of images, wherein the plurality of images includes the image, and wherein the respective weights include the weight.

2. The apparatus of claim 1, wherein the at least one processor is configured to:
determine a pose of the apparatus in the environment based on the features tracked in the plurality of images and according to the respective weights for the features of the environment in the plurality of images.

3. The apparatus of claim 2, wherein the at least one processor is configured to:
minimize weighed least squares of reprojection errors according to the respective weights of the features of the environment in the plurality of images to determine the pose of the apparatus in the environment.

4. The apparatus of claim 2, wherein the at least one processor is configured to:
output an indication of the pose of the apparatus.

5. The apparatus of claim 1, wherein the at least one processor is configured to:
map the environment based on the features of the environment tracked in the plurality of images and according to the respective weights of the features of the environment for the plurality of images to generate a map of the environment.

6. The apparatus of claim 5, wherein the at least one processor is configured to:
determine a location of the apparatus within the map of the environment based on the features of the environment tracked in the plurality of images and according to the respective weights of the features of the environment for the plurality of images.

7. The apparatus of claim 5, wherein the at least one processor is configured to:
output at least a portion of the map of the environment.

8. The apparatus of claim 1, wherein the respective weights for the plurality of images correspond to respective error variance values for the features of the environment across the plurality of images, wherein the at least one processor is configured to track the features of the environment across the plurality of images according to the respective error variance values for the plurality of images to track the features of the environment across the plurality of images according to the respective weights for the features of the environment across the plurality of images.

9. The apparatus of claim 1, wherein the at least one processor is configured to:
determine the estimated motion blur level for the at least one of the features of the environment in the image.

10. The apparatus of claim 1, wherein the estimated motion blur level for the at least one of the features of the environment in the image is based on a distance from the at least one image sensor to the at least one of the features of the environment, wherein the weight associated with the at least one of the features of the environment in the image is based on the distance from the at least one image sensor to the at least one of the features of the environment.

11. The apparatus of claim 1, wherein the at least one processor is configured to:
determine a ratio of a constant divided by the estimated motion blur level for the image to determine the weight associated with the image based on the estimated motion blur level for the at least one of the features of the environment in the image.

12. The apparatus of claim 1, wherein the at least one processor is configured to:
determine that the estimated motion blur level is less than a predetermined threshold; and
set the weight associated with the at least one of the features of the environment in the image to a predetermined value in response to determining that the estimated motion blur level is less than the predetermined threshold to determine the weight associated with the at least one of the features of the environment in the image based on the estimated motion blur level for the at least one of the features of the environment in the image.

13. The apparatus of claim 12, wherein the predetermined threshold represents a magnitude of motion blur that is no larger than a pixel.

14. The apparatus of claim 1, wherein the estimated motion blur level is an estimated magnitude of motion blur.

15. The apparatus of claim 1, wherein the image capture setting includes an exposure time.

16. The apparatus of claim 1, wherein the apparatus is at least one of a mobile device, a wireless communication device, or an extended reality device.

17. A method for imaging, the method comprising:
receiving an image of an environment captured using at least one image sensor according to an image capture setting;
receiving motion data captured using a motion sensor;
determining a weight associated with at least one of a plurality of features of the environment in the image based on an estimated motion blur level for the at least one of the features of the environment in the image, wherein the estimated motion blur level is based on the motion data and the image capture setting; and
tracking the features of the environment across a plurality of images according to respective weights for the features of the environment across the plurality of images, wherein the plurality of images includes the image, and wherein the respective weights include the weight.

18. The method of claim 17, further comprising:
determining a pose of a device in the environment based on the features tracked in the plurality of images and according to the respective weights for the features of the environment in the plurality of images, wherein the device includes the at least one image sensor and the motion sensor.

19. The method of claim 18, further comprising:
minimizing weighed least squares of reprojection errors according to the respective weights of the features of the environment in the plurality of images to determine the pose of the device in the environment.

20. The method of claim 18, further comprising:
outputting an indication of the pose of the device.

21. The method of claim 17, further comprising:
mapping the environment based on the features of the environment tracked in the plurality of images and according to the respective weights of the features of the environment for the plurality of images to generate a map of the environment.

22. The method of claim 21, further comprising:
determining a location of a device within the map of the environment based on the features of the environment tracked in the plurality of images and according to the respective weights of the features of the environment for the plurality of images, wherein the device includes the at least one image sensor and the motion sensor.

23. The method of claim 21, further comprising:
outputting at least a portion of the map of the environment.

24. The method of claim 17, wherein the respective weights for the features of the environment across the plurality of images correspond to respective error variance values for the plurality of images, further comprising:
tracking the features of the environment across the plurality of images according to the respective error variance values for the plurality of images to track the features of the environment across the plurality of images according to the respective weights for the features of the environment across the plurality of images.

25. The method of claim 17, further comprising:
determining the estimated motion blur level for the at least one of the features of the environment in the image.

26. The method of claim 17, wherein the estimated motion blur level for the at least one of the features of the environment in the image is based on a distance from the at least one image sensor to the at least one of the features of the environment, wherein the weight associated with the at least one of the features of the environment in the image is based on the distance from the at least one image sensor to the at least one of the features of the environment.

27. The method of claim 17, further comprising:
determining a ratio of a constant divided by the estimated motion blur level for the image to determine the weight associated with the image based on the estimated motion blur level for the at least one of the features of the environment in the image.

28. The method of claim 17, further comprising:
determining that the estimated motion blur level is less than a predetermined threshold; and
setting the weight associated with the at least one of the features of the environment in the image to a predetermined value in response to determining that the estimated motion blur level is less than the predetermined threshold to determine the weight associated with the at least one of the features of the environment in the image based on the estimated motion blur level for the at least one of the features of the environment in the image.

29. The method of claim 28, wherein the predetermined threshold represents a magnitude of motion blur that is no larger than a pixel.

30. The method of claim 17, wherein the image capture setting includes an exposure time.
